(19) United States
(12) Patent Application Publication
(10) Pub. No.: US 2003/0174648 A1
(43) Pub. Date: Sep. 18, 2003

(54) Content delivery network by-pass system

(76) Inventors: Mea Wang, Winnipeg (CA); Jose Alejandro Rueda, Winnipeg (CA)

Correspondence Address: ADE & COMPANY, 1700-360 MAIN STREET, WINNIPEG, MB, R3C3Z3, CA

(21) Appl. No.: 10/272,299

(22) Filed: Oct. 17, 2002

Related U.S. Application Data
(60) Provisional application No. 60/329,527, filed on Oct. 17, 2001.

(51) Int. Cl. H04L 1/00

(52) U.S. Cl. 370/235; 370/230

(57) ABSTRACT

The bypass network is designed to provide fast access and high quality streaming media services anywhere anytime. There are five major components including Peering Gateway, Content Locator, Edge Server, Gateway and Client. The whole bypass network is divided into number of self-managed sub-networks, which are referred as local networks in this document. Each local network contains Edge Servers, gateways, and a Content Locator. The Edge Servers serve as cache storage and streaming servers for the local network. The gateways provide a connection point for the client computers. Each local network is managed by a Content Locator. The Content Locator handles all client requests by communicating with the Peering Gateway and actual web sites, and makes the content available on local Edge Servers. The Content Locator also balances the load on each Edge Server by monitoring the workload on them. One embodiment is designed for home users whose home machine does not move around frequently. A second embodiment is designed for business users who travel around very often where the laptops would self-configure as a client of the network.

This application claims priority under 35USC119 from U.S. Provisional Application Serial No. 60/329,527 filed Oct. 17, 2001.

### THE FIELD OF THE INVENTION

The Internet is growing rapidly and playing an important role in today's society. As the number of Internet users increases on daily basis, expectation of Internet service is getting higher than ever. Internet users cannot be satisfied by plain text and graphic web pages. Instead, they expect to bring real life into cyber space. Real time chatting, online TV, online radio station and other forms of media has become available on the Internet. Streaming media is one of the Internet multimedia technologies providing real time data transfer with high security and quality performance. Normal multimedia file can take up fair amount of storage on hard disk. Transferring such file over the Internet obviously would require high bandwidth and sophisticated latency management, which makes sure the file could be play smoothly.

A new form of network, Content Delivery Network (CDN), was born to improve performance of streaming media. This type of network combines the caching technique and distributed nature of the Internet to deliver requested content efficiently and optimizing traffic on the Internet. CDN achieves the quality streaming media over the Internet by combining itself with web caching and content peering technique. Content Delivery Networks balances the server load and network traffic by transmitting the data from the origin servers to a server, which is near to the clients, via very fast connections to bypass the congested Internet. Web caching services store the recent and frequent requested content on the servers close to the clients in order to shorten the retrieval time and cost. Content peering join CDNs together to increase caching capacity and scale up the network to cover bigger geography area. The major advantage of the Content Delivery Network is that it transfers streaming media at high speed and avoids network congestion at the same time.

Since the leading edge network transmission technologies, such as Optical Networks, allow data being transferred at very high rate, it is used in CDNs to reduce latency as much as possible. Any large content can be transfer to the clients in time for playing.

Terminology:

CDN, ISP, Cache, OSPF, QoS, edge server, Content Locator, Peering Gateway, peer edge server, neighbor edge server, configuration free

### DESCRIPTION OF RELATED ART

Keywords:

IP routing techniques: RIP, OSFP, MPLS, VPN

Content Delivery Network Systems: Sun streaming CDN, Nortel MPLS CDN, and Akamai systems

Content servers and router

Session Initiation Protocol

Market Review:

Akamai

The Akamaized web sites need to only maintain a minimal portion of the actual web pages. The constant portion of the web pages, such as pictures and audio, can be stored at EdgeSuite. Upon the user's requests, the EdgeSuite combines the latest information from the origin web site and the content in the local cache, then it delivers the result page global wide. There are sounds of EdgeSuite scatter around the world to provide wider coverage of geographical area and bigger cache size. This architecture improves data transfer speed dramatically and brings more business to the subscribed companies.

Quoting from their web sites, “Unique to ESI is a mechanism for managing content transparently across Application Server solutions, Content Infrastructure, Content Management Systems and CDNs.”

The routing technique employed by Akamai is common to all CDN systems. The system continuously monitors the network and determines the fastest or least congestion path to the destination. Each EdgeSuite maintains an up-to-date map of the best routes to avoid Internet outages, congestions, and other content roadblocks.

Media file in any format and size can be delivered at any bandwidth to any audience. Each EdgeSuite has sufficient storage to cache large amount of media files. The popular or latest media files are replicated quickly on the Akamai system to make the content available any time to the user. As a result, the network congestion can be avoided efficiently. Their FreeFlow Streaming network provides high performance streaming media and can be scaled up unlimited.

EdgeSuite Content Targeting is another technology developed by Akamai to accurately identify the geographic location of the requester, connection speed, device type, browser type and other information for each content request. This allows the Akamai determines the EdgeSuite, which is closest to the requester. Therefore the content can be delivered to the user even faster and data being transferred on the network is reduced.

InfoLibria

InfoLibria system contains three major components, Content Commander, MediaMall, and DynaCache. All three components are managed by the InfoLibria Content Operating System (COS).

The Content Commander manages the replication and the distribution of the web contents onto the edges of the network. MediaMall maintains a copy of the media content only a hop or two away from the user. It improves performance by reducing the transfer time. DynaCache at the edge of the network stores web objects to speed up the access time while minimizing bandwidth demand and optimizing network usage.

DynaLink redirector makes sure extra data is not received by overloaded DynaCache to avoid packet losts and network congestions. For example, if the HTTP request rate of DynaCache is exceeded the maximum capaticity, either DynaLink or the Layer 4 switch forwards subsequent HTTP requests deeper into the network.

Content Bridge Alliance

Defined on Content Bridge web sites, Content Bridge is an Alliance of industry-leading technology and service providers dedicated to enabling the next generation of content distribution services. This system is design to improve the performance and QoS of the web through a cooperative content distribution model.

There are two major problems with CDN. According to “Content Peering: The Foundation for the Content Bridge Alliance”, proprietary content distribution solutions fragment the Internet, making it more difficult for networks to scale and share information. They also lack the flexibility to quickly satisfy demands for new types of content and services as they emerge. Many of the key players are either negatively impacted by the process or are simply not benefiting from their participation in it.

There are two key attributes of Content Bridge services. One is the ability to distribute content directly into the access networks located at the true edge of the network, the other one is that it provides an infrastructure for cross-network content sharing that aligns the economic interests of all participants in the content distribution process.

Content peering connects separate networks together to offer greater customization and fewer changes to the existing architecture. This improves the scalability, visibility and services that reward all key players.

Edgix

The Edgix system is built inside ISP or NSP networks. The software is resides on the edge of the network in order to bypass the congested Internet. By storing the content on the edge of networks, Edgix brings the content closer to the end user and improves network performance. According to Edgix web sites, “ISPs benefit from the network effect of the Edge Delivery Platform: the value of the service increases as the number of edge nodes grows because Edgix' adaptive technology collects more information from a greater pool of end users.”

Speedera

Speedera distributes its cache servers on the major backbone of the Internet worldwide. The cache servers would be used potentially to allow quicker access and faster transfer. By putting the content closer to the user, it avoids delays caused by congested Internet. This system mainly supports HTTP, SSL and FTP requests. No streaming media found on the web site.

Digital Island

Digital Island designed an Intelligent LAN to avoid the bottleneck congestion on local networks. It also uses Cisco Systems LocalDirector to enable fault tolerant, locally load-balanced connectivity. Various security system issue, including network security authentication, authorization, administration, and accounting practices, are considered in this system. Digital Island's Globeport package provides connectivities from their customers' networks into Digital Island's Intelligent Network.

The Enabling technologies are the key to the whole Digital Island CDN system. The Enabling technologies include Data Center, Commerce Content Distributors (CCDs), Content Distributors (CDs), and various types of customer supports. The Data Center is similar to a cache server, which increases data availability and provides redundancy for disaster recovery. CCDs manage the distribution of the content in order to bring the content closer to the end users. This technique significantly reduces the transfer cost by avoiding transferring data over the Internet as much as possible. CDs are similar to local caching engines. Each ISP or NSP has to install this component on the local network to gain access to the Digital Island system.

The Footprint network provides the intelligent technique for content delivery. Quoting from their web sites, “Footprint now provides the most comprehensive security and authentication features of any CDN on the market. FootprintSecure complements the other features like Cookie-based or Querystring-based Authentication, HTTP authentication to provide the best distributed platform for secure, and authenticated content delivery.” Footprint handles requests in three simple processes: preparation, routing, and delivery. The preparation process simple chooses the content to be delivered. The routing process uses their intelligent probes transparently direct the customer to the closest and fastest server. TraceWare developed by Digital Island does the intelligent probing to monitor the network continuously. The delivery process delivers the content on the Footprint network, which offers faster transfer rate and high quality.

Enabling technologies are employed in the content delivery system. Caching, mirroring and streaming media are the key technologies used here. Mirroring technology replicates the content into secure area across the Intelligent Network to the CCDs. According to the web sites, “Caching plays a critical role in enhancing end-user performance around the globe while simplifying IT management tasks, and reducing costs to deliver content reliably.” “As a result of Streaming media technology, on-demand audio, video, and animation hosted by Digital Island is smooth and reliable because streams are not interrupted by Internet congestion or bottlenecks.”

Market Analysis

Market Summary

So far, six existing CDN systems have been reviewed. The Akamai is a great system for the content provider. However it requires changes on each content provider. When the end users try to access a non-Akamaized web site, the performance would not be improved at all. To solve this problem, InfoLibria builds a stand-alone system and makes modification of the servers on the edge of each network. Each participating ISP has to install a intelligent layer on their edge servers. Edgix and Speedera are smaller scale CDN systems, which are more or less same as the InfoLibria system. The Speedera mainly supports text-based web transactions, such as HTTP, SSL and FTP. Their web site did not mention any streaming media technology. Content Bridge Alliance distinguishes itself from the above systems by peering the existing networks. The content peering benefits all key players on the Internet, including content provider, web hosts and access providers. It creates a new level of scalability, visibility and service for all participants. Integrating all the advantage of the existing CDN system, Digital Island designs great technologies to peer all the ISPs and link them to their Intelligent LAN to bypass the congested Internet. Each ISP only has to install their CDs in order to gain access to the Intelligent LAN. No other participants need to make changes. The CCDs manages all the participating ISPs as a whole.

### OBJECT AND SUMMARY OF THE INVENTION

The world is changing everyday and people travel more than ever. Mobile PCs, such as laptops and handheld PCs, allow computer users to travel with their own computers. In these days, most airports and hotels provide Internet access for laptops. However, is the Internet access at these sites as convenience and high quality as their home networks? The laptops are configured to meet their own cooperate network requirements. First of all, the users have to reconfigure their laptops according to network architecture at each site as they travel. This problem has already been solved elsewhere in the literature, which allows the computer users simple plug their machines to the network and surf. This document introduces an enhanced system, called IntelletNet. This system not only provides configuration free access for the client, but also provides server load balancing and traffic control services. Nonetheless, the network might not provide high quality service as their home networks. This project is designed to solve this problem using the CDN technologies. In other words, Internet users can have high quality services travel with them around the world as long as they subscribe to the ISP's CDN services. Very similar to Digital Island system, the particular ISP can set up few CDN at different geography region across the country. For outside country services, the ISPs can have peering agreements with several ISPs in the foreign countries and have high-level access to their CDNs. The customers of this ISP can access the CDN anywhere around the world via the peered networks.

The size of content provided by the content providers is growing rapidly. For instance online movie provider or music provider adds new release from on daily basis. Soon the provider would have to increase the capacity of the server storage. Similarly with ISPs, as multimedia becomes popular in cyber space, bigger cache size is required to maintain high quality performance. The CDN bypass system solved this problem by sharing resources among peered networks. Content providers can share their storage and content with other providers upon certain peering agreements. The ISP can share cache with other ISPs the same way. Very similar to Akamai, the contents are made available on the edge of the networks to avoid network congestion. However, instead of using static caching, our system caches the content upon requests only in order to use the cache storage wisely. This approach frees the content providers from inconsistent cache information among all the servers.

The Internet is growing rapidly and playing important role in today's society. As the number of Internet user increases on daily basis, expectation of Internet service is getting higher than ever. Internet users cannot be satisfied by plain text and graphic web pages. Instead, they expect to bring real life into the cyber space. Real time chatting, online TV, online radio station and other forms of media became available on the Internet. Streaming media is one of the Internet multimedia technologies providing real time data transfer with high security and quality performance. Normal multimedia file can take up fair amount of storage on hard disk. Transferring such file over the Internet obviously would require high bandwidth and latency management, which makes sure the media could be play smoothly.

The system includes a next generation content delivery network and the signaling protocol for a by-pass architecture that will be applicable to new high-bandwidth services. The architecture involves Content Delivery Networks (CDNs), which move high-demand content away from its originating host, and place it on servers at the Internet's edge. Thus, when a user requests a high-demand resource, the user's software is generally referred to one of these caches. The CDNs are primarily used in transferring streaming media due to its large size of high performance demand. Unlike the existing CDNs, this project employees dynamic caching since the media file size is extremely large and cache capacity is limited. The proposed dynamic caching scheme balances the load among the cache servers and uses the limited storage efficiently. By using SIP, any newly added server can merge into system automatically, and the user can log on to the network anywhere at any time and still have access to his/her personalized account information. More than one Internet Service Provider (ISP), which has this system setup on their networks, will be able to establish peer relationships between the networks based on certain agreements. This will allow each participating ISP to expand their geographical coverage easily. The user would not have to subscribe to new ISP when moving around. In order to avoid network congestion and archive load balancing, network and server load is encountered when routing the data.

As the result of this invention, web sites will be able to attract more visitors with their value-added enhancements regardless of the file sizes. The ISPs will provide high quality network services, balancing the network traffic at the same time. Internet users will be able to save time on waiting for the content and still receive high quality performance.

Key benefits:

The system provides worldwide access for the ISP subscriber to the high performance network. Users need not to subscribe to different ISP at when traveling. SIP is an application layer protocol, which supports mobility and provides worldwide access to the network.

User account information can be access anywhere around the world. For security issue, the system can prevent user logging on from two different locations simultaneously.

Locating the content on the bypass network is transparent to the user. The subscribed user can get same high quality server all around the world without knowing the underlying architecture of the network and knowledge on configuring the client machine

Reliable network services. The network is not heavily relying on one Edge Server for cache and streaming services. The Content Locator constantly updates the status and assigned jobs to Edge Servers according to their current load. With distributed Content Locator, the network is not heavily relying on one single managing server. If one Content Locator is down, only the customers, who is currently connect to it, would be affected.

Load balancing. Each edge server is response to computer its percentage of load. This relieves the Content Locator from computing and network traffic. The Content Locator determines the least busy Edge Server dynamically to actively balancing the load.

Scalability. The ISP with bypass network service can easily scale up their network by peering with other ISPs. By using SIP to initiate communication tunnel, any newly added Edge Server can be used without manually configure the Content Locator. Similarly, any new local network available on the bypass network, the Peering Gateway could add the Content Locator to its list automatically.

Services Sharing. When ISPs establish peer connections, they can share their edge server contents upon certain agreements. The participating ISPs can lower the cost on increasing offline storage size.

Independency. Each organizations subscribed to the ISPs would be configured as one or more local networks, which maintains their own peering agreements. The organizations, which do not have peering agreement, would not know each other's existence on the bypass network.

Attracting more visits. The content provider may have multimedia content embedded into their web sites regardless the file size. Interactive movie and broadcast live could be easily done over the CDN bypass network. With the enhanced web content, the web site could attract more visitors, which could end in more profit to the company and higher reputation.

Content Sharing. When content providers establish peer connections, they can share their edge server contents upon certain agreements. The participating content providers can lower the cost on increasing offline storage size.

Moovy MediaWork

The Moovy MediaWork takes the advantages of the CDN and adds extra values to it. This system sets up a bypass network with Gigabit connections in parallel to the Internet connection to provide fast transfer speed and generic QoS. The following sections address the main characters of the Moovy MediaWork system.

Content Delivery Networks (CDNs)

The content are transmitted from the original web server to one of the ISP's edge server upon requests. The location of the customer determines which edge server would be used as the destination. In order to locate the nearby edge server for the client, a centralized server maintains information about all existing servers on the bypass network. This allows all the servers to be aware of existence of and communicate with each other. While all servers on Moovy MediaWork have extreme fast network connections, they also running routing algorithm similar to OSPF in order to choose the fastest or least congested path when transferring data.

Web Caching Services

Each edge server on Moovy MediaWork caches the content access by its nearby client recently or frequently. The Content Locator has the knowledge of each edge server in order to response to queries and managing the transmission of the content. When a particular edge server does not have the request content, instead of transferring from the origin server, this edge server might directly get the content from its neighbors. The caching services on this bypass network save a lot of retrieval and transfer time, which is the major issue in streaming media.

Content Peering

Instead of having one centralized server managing hundreds of edge servers, the edge servers can be grouped by their geography location and managed by a local server called Content Locator, which maintains a database about each edge server. On a higher lever, a Peering Gateway manages all the Content Locators and maintains information about each local network. Still all edge servers on the bypass network can communicate with each other. The Content Locators obtain the information about peer network from the Peering Gateway. The other advantage of content peering is that it allows the Peering Gateway communicates with the Peering Gateway on another ISP to provide wider area QoS.

Smart Routing

A specially made router would be used on Moovy MediaWork. The router routes the data on the bypass link in an efficient way to prevent congestion. Since the topology of the whole network is known, the router could route data as OSPF does. This router locates the closest Peering Gateway to the original web server if the web server happens to be off the bypass network. This allows relatively faster download speed to the bypass network than download straight to the end user across the congested Internet. The advantage of using this router is to route the content to the nearest bypass network so the content can arrive at the destination faster.

Transparent Content Location

The Content Locator detects large file transfer by parsing the requests. If large file transfer is detected, the Content Locator locates the requested content on the local edge servers and searches on the edge servers on the peered networks as necessary. The web servers on Moovy MediaWork follow the similar scheme to find the requested content. However, the content locating processes are transparent to the end user. The Internet user would not know the existence of this bypass network. The end result of each Internet request would be same as any other regular Internet requests except the performance would be much better.

Dynamic Content Location

For large file requests, the Content Locator would try to locate the requested content in its edge servers. If failed, it would search on the edge servers on the peered networks. Upon requests the web servers on Moovy MediaWork, follows the similar scheme to find the requested content for the end user. Whether the content are found on local network, peered networks or web server networks, the goal is to make the content available on one of the edge server close to the user. The advantage of dynamic content locating scheme over the static content locating scheme is that it gives the edge servers flexibilities. The edge servers can cache or delete cache content any time as necessary to use the storage wisely.

Benefits/Features:

All participants could benefit from this network design. This section outlines the benefits to the end users, service providers, and content providers.

End Users:

Users need not to subscribe to different ISP at different locations.

Users need not reconfigure the computer to gain access to quality network services.

User account information can be access anywhere around the world. For security issue, the system can prevent user logging on from two different locations simultaneously.

The subscribed user can get same high quality server all around the world without knowing the underlying architecture of the network.

The sophisticated signaling on the network ensures that content locating process is transparent to the end user.

Service Providers:

By distributing Content Locators on each local network, Moovy MediaWork is not heavily relying on one single managing server. If one server is down, the nearby server can serve the requests as backup.

Each edge server is response to computer its percentage of load. This relieves the Content Locator from computing and network load.

The Content Locator determines the least busy Edge Server dynamically to actively balancing the workload.

By using SIP to initiate communication tunnel, any newly added Edge Server can be used without manually configure the Content Locator. Similarly, any local network newly available on the bypass network, the Peering Gateway could add the Content Locator to its list automatically.

Reliable network services. The network is not heavily relying on one Edge Server for cache and streaming services. The Content Locator constantly updates the status and assigned jobs to Edge Servers according to their current loads.

Scalability. The ISP running Moovy MediaWork can be easily scaled up their network by peering with other ISPs.

Sharing. When ISPs establish peer connections, they can share their edge server contents upon certain agreements. The participating ISPs can lower the cost on increasing offline storage size.

Independency. Each organizations subscribed to the ISPs would be configured as one or more local networks, which maintains their own peering agreements. The organizations, which do not have peering agreement, would not know each other's existence on the bypass network.

Content Provider:

Enhanced web content. The content provider may have multimedia content embedded into their web sites regardless the file size. Interactive movie and broadcast live could be easily done over Moovy MediaWork.

Attracting more visitors. With the enhanced web content, the web site could attract more visitors, which will result in more profit to the company and higher reputation.

Sharing. When content providers establish peer connections, they can share their edge server contents upon certain agreements. The participating content providers can lower the cost on increasing offline storage size.

Independency. Each content provider subscribed to the ISPs would be configured as one or more local networks, which maintains their own peering agreements. The content providers, which do not have peering agreement, would not know each other's existence on the bypass network.

### THE FUTURE

In the 80's, the computer network is thought as leading edge technology, and is used rarely. In these days, the Internet has become an inseparable part of people's daily life. In the early 90's, it was hard to imagine owning a personal computer (PC) or laptop with a PIII 800 MHz CPU, 20 GB hard drive, and 256 MB of memory. However, the above description is the standard for most home PCs today. There are many things exist on the Internet that people dreamt about 10 years ago. For instance, web TV, Internet phone, wireless Internet access. The computer network industry grows relatively faster than other industries. In few years, standard home PC or laptop would have GigaHz CPU, TaraByte hard drive, GigaByte memory, and Gigabit network connection. Computer users could do almost everything over the Internet promptly.

One of the big revolutions might be the movie industry. In the old days, movies are recorded on VHS tape and played on VCR, which uses analog instead of digital for signalling. As the home PC become popular, one movie can be stored on 2 compact disks, which is called VCDs. Multiple language channels are encoded in the VCDs, so the movie can be played in different languages. Even better, DVD technology bring much better quality of the sound and picture. In additional to the original movie and multi-language, many other features can be included in the DVD since it has bigger capacity than regular CDs. Most DVD has features such as soundtrack music, interactive games, scene selection, backstage or deleted scenes, and director's documentary.

Imagine sitting at comfortable couch and watching latest released movies on home theatre system. Imagine making choice of how you want the stories in the movie ends. Imagine being the director and choose the camera angle for the best desirable view. Imagine ordering the cool merchandises online well watching the movies. This is achievable in the near future. However, more storage is required since each part of the movie has multiple versions to meet the viewers the requests. In other words, instead of using DVD storage, network storage must be employed since its capacity can be thousands times bigger than DVD's. It might sounds like a dream today, but it will become true in the near future. Soon, home PC would have GigaHz CPU, TaraByte hard drive, Gigabyte memory, and Gigabit network connection. People can view the movie at home with even better sound and picture quality since bigger capacity allows enhancement unlimitedly.

This project is to design a network system, which allows seamless transformation of data with large size, as well as optimising the usage of network resources. This is a dream come true. This network system integrates the Content Delivery Network (CDN), SIP signalling, and Media Extraction Access protocol to provide easy access QoS worldwide. The primary character of CDN is that it brings the requested content to the server which is closest to the end user. Within the CDN, GigaBit connection exists between connected servers to provide fastest data transfer rate. Transferring a movie with size of few gigabytes can be done in seconds. The servers on the network maintain information about their neighbours and load states. When the data packets arrive, best route to the destination is picked dynamically in order to reduce and avoid network congestion. Forwarding path and caching server is chosen dynamically as well. By doing so, the load on each server is balanced, and the network is not heavily relied on small number of resources. In other words, the workload is evenly distributed among the servers. As a result, the downtime of the network can be greatly minimized. Other advantage is that the system can detect any dead links and avoid traffic through them. Since the interactive movie and similar media file takes enormous space, it is crucial to use network cache storage wisely. The content are delivered to the edge server upon the requests and resides in the cache for only short period of time. This technology is known as dynamic caching. Mobility services provided by SIP allow worldwide access to the network. It also allows the server to self-configure according to changes on the network. For example, when a new server or network is available, SIP is used to make the neighbours aware of existence without manually configuring the network information. The detail of each technology would be covered in detail through out this document.

### BRIEF DESCRIPTION OF THE FIGURES

FIG. 1 illustrates overall system architecture.

FIG. 2 illustrates the log on/off in case the user is a customer of the ISP.

FIG. 3 illustrates the log on/off in case the user is a customer of the peered ISP.

FIG. 4 illustrates the client request handling in case the content is on the closest Edge Server.

FIG. 5 illustrates the client request handling in case the content is found on the bypass network.

FIG. 6 illustrates the client request handling in case the content is on a peered local network on other bypass network.

FIG. 7 illustrates the client request handling in case the content is not found.

FIG. 8 illustrates the web request handling in case the content is found on the web server.

FIG. 9 illustrates the web request handling in case the content is on the other Edge Server of the local network.

FIG. 10 illustrates the web request handling in case the content is on a peered local network.

FIG. 11 illustrates the web request handling in case the content is on a peered local network on other bypass network.

FIG. 12 illustrates recovery of request handling failure.

FIG. 13 illustrates the data structure on the Peering Gateway.

FIG. 14 illustrates the data structure on the Content Locator.

FIG. 15 illustrates the use case for SIP log on success.

FIG. 16 illustrates the use case for SIP log on failure.

FIG. 17 illustrates the use case for SIP server not found.

FIG. 18 illustrates the adding a new user using SIP.

FIG. 19 illustrates how SIP message hide the previous machines location information.

FIG. 20 illustrates how SIP uses max-forward to prevent malicious actions.

FIG. 21 illustrates how SIP records the route of each packet.

FIG. 22 illustrates the load balancing feature in the IntelliNet.

FIG. 23 illustrates how the request is process according to the priority rules.

FIG. 24 illustrates the overall system architecture of the IntelliNet.

FIG. 25 illustrates how the three main programs work together.

FIG. 26 illustrates how the connection{} and fd_index[] are related.

FIG. 27 illustrates how each packet gets passed around in the program.

FIG. 28 illustrates normal HTTP request.

FIG. 29 illustrates HTTP request with proxy server.

FIG. 30 illustrates HTTP request over IntelliNet.

FIG. 31 shows the format of the packet of both proxy request and non-proxy request.

FIG. 32 illustrates normal FTP request.

FIG. 33 illustrates FTP request over IntelliNet.

FIG. 34 illustrates normal SMTP request.

FIG. 35 illustrates SMTP request over IntelliNet.

FIG. 36 illustrates normal DNS request.

FIG. 37 illustrates DNS request over IntelliNet.

FIG. 38 illustrates normal SIP connection.

FIG. 39 illustrates SIP over IntelliNet.

FIG. 40 illustrates detail transaction of normal SIP connection.

FIG. 41 illustrates detail transaction of SIP over IntelliNet.

FIG. 42 illustrates the different states of both data structures in SIP connection process.

FIG. 43 illustrates the transaction of log on process in case the user is a customer of the ISP.

FIG. 44 illustrates the transaction of log off process in case the user is a customer of the ISP.

FIG. 45 illustrates the transaction of log on process in case the user is a customer of the peered ISP.

FIG. 46 illustrates the transaction of log off process in case the user is a customer of the peered ISP.

FIG. 47 illustrates the transaction of client request handling in case the content is on the closest Edge Server.

FIG. 48 illustrates the transaction of client request handling in case the content is found on the peered local network.

FIG. 49 illustrates the transaction of client request handling in case the content is not found.

FIG. 50 illustrates the transaction of web request handling in case the content is found on the web server.

FIG. 51 illustrates the transaction of web request handling in case the content is on the other Edge Server of the local network.

FIG. 52 illustrates the transaction of web request handling in case the content is on the peered local network.

FIG. 53 illustrates the transaction of recovery of request handling failure.

FIG. 54 illustrates the self-configuration on startup of each component on the network.

FIGS. 55.a, b, c, and d are the flow charts for the Peering Gateway.

FIGS. 56.a and b are the flow charts for the Content Locator.

FIG. 57 is the flow charts for the Edge Server.

FIG. 58 is the flow charts for the IntelliGateway.

FIG. 59 is the flow charts for the SmartClient.

### BRIEF DESCRIPTION OF THE ALGORITHMS

Algorithm 1 shows that the account information is maintained in class Account.

Algorithm 2 shows that the transaction information is maintained in class Transaction.

Algorithm 3 shows that the class Requestlist keeps track of the existing requests on the network.

Algorithm 4 shows that the class LocalNetwork contains the information about all local networks.

Algorithm 5 shows that the class BypassNetwork contains the information about all bypass networks.

Algorithm 6 shows the main method on the Peering Gateway.

Algorithm 7 shows the Peering Gateway Algorithm code for the log on process.

Algorithm 8 shows the Peering Gateway Algorithm code for the log off process.

Algorithm 9 shows the Peering Gateway Algorithm code for the network status update process.

Algorithm 10 shows that the class EdgeServer contains the information about all edge servers on this local network.

Algorithm 11 shows the main method on the Content Locator.

Algorithm 12 shows the Content Locator Algorithm code for the log on process.

Algorithm 13 shows the Content Locator Algorithm code for the log on confirmation process.

Algorithm 14 shows the Content Locator Algorithm code for the log off process.

Algorithm 15 shows the Content Locator Algorithm code for the log off confirmation process.

Algorithm 16 shows the Content Locator Algorithm code for the request handling in case a new request issued by the user.

Algorithm 17 shows the Content Locator Algorithm code for the request handling in case a response list has been generated.

Algorithm 18 shows the Content Locator Algorithm code for sending a request.

Algorithm 19 shows the Content Locator Algorithm code for web response handling.

Algorithm 20 shows the Content Locator Algorithm code for broadcast/multicast response handling.

Algorithm 21 shows the Content Locator Algorithm code for choosing the right edge server in the response list as the streaming source server.

Algorithm 22 shows the Content Locator Algorithm code for edge server status update process.

Algorithm 23 shows the main method on the Edge Server.

Algorithm 24 shows the Edge Server Algorithm code for broadcast process handling.

Algorithm 25 shows the Edge Server Algorithm code for acknowledgement handling.

Algorithm 26 shows the Edge Server Algorithm code for notification handling.

Algorithm 27 shows the Edge Server Algorithm code for request and broadcast handling.

Algorithm 28 shows the Edge Server Algorithm code for server load computation.

Algorithm 29 shows the main method on the IntelliGateway.

Algorithm 30 shows the IntelliGateway Algorithm code for request response handling.

Algorithm 31 shows the main method on the SmartClient.

Algorithm 32 shows the SmartClient Algorithm code for request response handling.

Algorithm 33 shows the SmartClient Algorithm code for probing an existing content locator on the local network.

Algorithm 34 shows the SIP implementation on the SmartClient.

Algorithm 35 shows the UDP setup using SIP on the Content Locator.

Algorithm 36 shows the SIP implementation of the message transportation.

Algorithm 37 shows the SIP implementation of max-forward.

Algorithm 38 shows the main method of the IntelliNet program.

Algorithm 39 shows http_connection( ) function.

Algorithm 40 shows http_handler( ) function.

Algorithm 41 shows ftp connection( ) function.

Algorithm 42 shows ftp_handler( ) function.

Algorithm 43 shows smtp_connection( ) function.

Algorithm 44 shows smtp_handler( ) function.

Algorithm 45 shows dns_connection( ) function.

Algorithm 46 shows dns_handler( ) function.

Algorithm 47 shows sip_connection( ) function.

Algorithm 48 shows sip_handler( ) function.

### DETAILED DESCRIPTION

System Architecture:

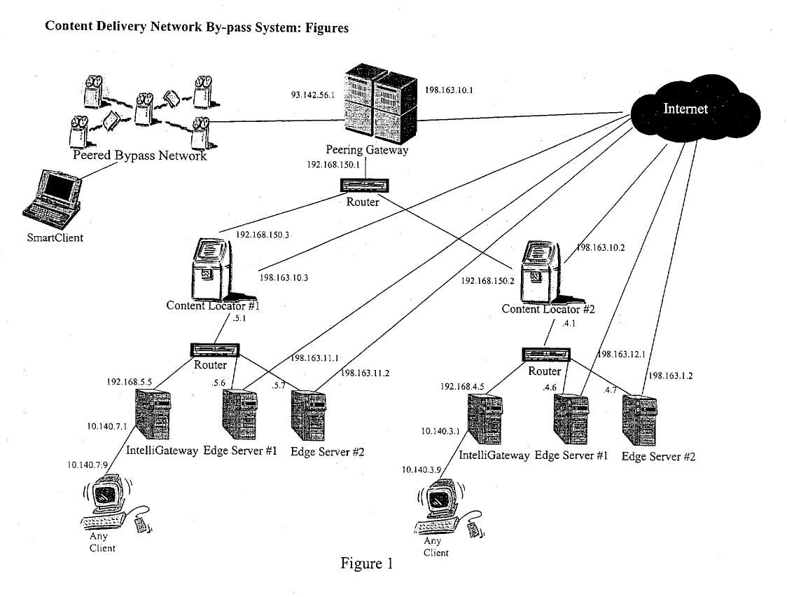

The CDN bypass network is designed to provide fast access and high quality streaming media services anywhere anytime. There are five major components including Peering Gateway, Content Locator, Edge Server, Gateway and Client. The whole bypass network is divided into number of self-managed sub-networks, which are referred as local networks in this document. As shown in FIG. 1, each local network contains Edge Servers, gateways, and a Content Locator. The Edge Servers serve as cache storage and streaming servers for the local network. The gateways provide a connection point for the client computers. Each local network is managed by a Content Locator. The Content Locator handles all client requests by communicating with the Peering Gateway and actual web sites, and makes the content available on local Edge Servers. The Content Locator also balances the load on each Edge Server by monitoring the workload on them.

There are two different designs, Intelligateway design and SmartClient design. The Intelligateway is designed for home users whose home machine does not move around frequently. The SmartClient is designed for business users who travel around very often. By installing SmartClient on their laptops, the laptops would detect nearby Moovy MediaWork and self-configure as a client of the network. This section gives description for both architectures, and addresses the differences and similarities.

IntelliGateway Design

This design requires Intelligateway being setup on each local network. The Intelligateway communicates with Content Locator and the edge servers to ensure high quality streaming connections. The IntelliNet provides configuration free access, server load balancing, and traffic control services.

The advantage of this design is that the system can provide high quality network services anywhere anytime for any client machine without reconfiguring the client machine or installing special software. In other words, it provides any machine high quality network services everywhere. The users simply plug the computer to the network and would experience high performance streaming media. The disadvantage of this design is that it requires IntelliGateway being setup everywhere on the bypass network. If the client machine is not on any of the designated local network, the customer might not be able to get the high quality services.

SmartClient Design

This design requires all customers, who access to Moovy MediaWork, to have the SmartClient installed on their machine. The SmartClient is almost same as the Intelligateway. Instead of having the intelligence on the gateway, the intelligence migrates onto the client machine. The SmartClient searches for Content Locator on the network, and communicates with selected Edge Server. Since the SmartClient functions very similar to a gateway, it can connect directly to the Content Locator without a gateway. The Content Locator would be the gateway to the Moovy MediaWork and the Internet for the SmartClient. If the SmartClient were not on any CDN bypass network, it would directly communicate with the home Peering Gateway over the Internet and find a nearby local network. The ISP could setup an Intelligateway on selected local networks to accept requests from clients connected on other networks.

The advantage of this design is that the system can provide high quality network services anywhere at any time without having a special gateway setting in each network. The services are accessible even from outside Moovy MediaWork, as long as the client machine installed the software and has Internet access. The only disadvantage of this design is that the SmartClient has to been installed on each client machine.

FIG. 1 illustrates the both Intelligateway design and SmartClient design. The IntelliGateway, edge servers, and Content Locator could actually locate at different physical sites. The router, which is the specially made for Moovy MediaWork, provides efficient routing by choose the shortest and most efficient path to the destination. Each network interface is labeled with an IP address. The regular clients (home users) are connected to the bypass network via the IntelliGateway. There is no need to install special software on these machines. The laptop running SmartClient, which is connecting to another ISP network, still can access the bypass high quality network. In both design account information would be transferred from the home Peering Gateway to current Content Locator. Once logged on, the customer can surf and view streaming media file with high performance. Notice that the self-configuration and transferring account information are unknown to the end user. The user can have completely no knowledge about the bypass network existence.

Design Problems:

Why two levels of servers? If the Content Locators do not exist, all the edge servers would directly connect to the Peering Gateway. This Peering Gateway would contain detail information about each edge server, and handle the requests from all clients. There are two approaches for handling requests.

First Approach: When a request arrives at Peering Gateway, the Peering Gateway sends the client a list of all existing edge servers on the network. The gateway/client would have to broadcast content queries to these servers and make decision upon the query results. The advantages of this approach are that the gateway/client can choose the edge server and relieve the Peering Gateway from choosing edge server to each requester. Peering Gateway is already very busy with maintaining customer account and edge server information. Eventually Peering Gateway would be overloaded with all the processes. The disadvantage of this approach is that lots of data are transferred around the network since the gateway/client needs to have enough information to make decisions.

Second approach: When a request arrives at the Peering Gateway, the Peering Gateway broadcast a content query to all existing edge servers on the network. Then the Peering Gateway would make decisions for the gateway/client upon the query results and inform the client about the decision. The advantage of this approach is that only the chosen edge server address being transferred to the client. The disadvantage of this approach is that the Peering Gateway does all computation. If there are a huge number of requests, Peering Gateway may slow down the processing speed by exceed amount of computations and eventually be overloaded.

A hybrid approach: As illustrated in FIG. 1, Peering Gateway workloads are distributed among the Content Locators and the network is partitioned into smaller local networks. Each Content Locator maintains the information about all local edge servers. The Peering Gateway maintains Moovy MediaWork and all customer accounts information. When the customer is logging on to certain local network, the account information is fetched from the Peering Gateway to the Content Locator. Upon the gateway/client's request, the Content Locator makes the content available on one edge server and informs the client/gateway the address of the source Edge Server. In this approach, only the information about the edge servers on this network is sent to the client/gateway. It also relieves the gateway/client from probing all edge servers on the network, which would generate fair amount of network traffic. In other words, this approach saves computation time on both server side and client side, reduces network traffic, and balances the load on all Edge Servers. In this architecture, the network can be scaled up easily by adding another local network. However, this approach requires higher degree of resource management and organization.

System Requirements:

One Peering Gateway with three network interfaces, one for Internet connection, one for other peering bypass network, and one for internal bypass network. This machine requires relatively high process speed in order to handle data forwarding extremely fast. The two interfaces connecting to the internal Moovy MediaWork and peered bypass network must have Gigabit connection to ensure seamless data transfer. The other interface has ordinary Internet connection for messaging.

One Content Locators for each local network. Each Content Locator has three network interfaces, one for Internet connection, one for local network, and one for the bypass network. This machine requires very high process speed in order to handle all client requests, content query broadcasts, and data forwarding. This is the busiest component in the system. The two interfaces connecting to the bypass network and local network must have Gigabit connection to ensure seamless data transfer. The other interface has ordinary Internet connection for messaging.

As many edge servers as necessary. Each edge server has two network interfaces, one for Internet connection, and one for local network. These machines do not require high processing speed since they serve primarily as caches, but they do require large secondary storage. The interface connecting to the local network must have Gigabit connection to ensure seamless data transfer. The other interface has ordinary Internet connection for messaging.

Few IntelliGateway with two network interfaces, one for local network, and one for the client. The number of Intelligateway depends on the expecting number of clients to be handled. This machine requires relatively high process speed in order to handle all clients equally. Both interfaces only require regular Internet connections for both data and message signaling. SmartClient or regular client requires only one network interface for network connection. This is machine can be any PC or laptop. The higher process speed, the better end results.

System Components:

This section gives a high level abstraction of each component in the architecture. The abstraction includes each component's formal definition, functionality, and the role played in the system.

Peering Gateway:

The Peering Gateway supervises the CDN bypass network as a whole. It functions as a user account database and the gateway to the peered bypass networks. The following are the core functionalities of this component.

Initialization: On startup of the program, it actively informs the Peering Gateways on the peered networks its existence. All peer networks can be aware of the newly peered network automatically.

Account Information: the Peering Gateway maintains all customers' account information. This provides easy log on anywhere services. The Peering Gateway validates the log on information by matching the record in the database and sends the account information to the Content Locator as confirmation. The log off information includes updated account information and recent transaction history. The Peering Gateway updates the record in the database accordingly. If the log on or log off information belongs to a peered network, the Peering Gateway simply passes the information to the appropriate network and forwards the confirmation to the Content Locator, which the customer is currently connecting to. If the log on or log off information belong to neither the home network nor the peered networks, it would reply with an access deny message.

Data Forwarding: When the requested content is being transfer from one bypass network to another, the content must be routed through the Peering Gateway in order to reach the destination edge server. The Peering Gateway received the data on one side of the Gigabit network, and sent out the data on the other side. This is no different from old fashion gateway.

Overall, the Peering Gateway supervises the CDN bypass network by managing the Content Locators. It is the gate to the peered networks and the user account database. A billing system can be built base on the information recorded in the database.

Content Locator:

The Content Locator supervises and monitors the local network. It handles requests and makes the requested content available on the local network. Each Content Locator maintains a list of peered networks. The peers might be on either the same bypass network as this Content Locator, or the peered bypass networks. In either case, the peered Content Locators communicate with each other via the Internet. Note that the Content Locators on the same bypass network are not necessary peers. In other words, they might not know each other at all. A web server can be run on the same machine as the Content Locator. The following is the core functionality of this component.

Initialization: On startup of the program, it actively informs Peering Gateway and peered Content Locators existence. Peering Gateway is aware of the newly available local network automatically.

Account Information: The log on information is forwarded to Peering Gateway by Content Locator regardless the home network of the customer. The Peering Gateway confirms by sending the account information as reply. The Content Locator maintains the account information of customers, who are currently connected to this local network. For each account, a recent transaction history would be associated with it. When the user logs off, the updated account information and recent transaction history are sent to the Peering Gateway. Upon confirmation of log off, the account information and transaction history are deleted on the Content Locator.

Handling Web Request: an Edge Server might forward the requests to the Content Locator if the Edge Server were the target web site. The requests might also arrive at the Content Locator directly from the requester if the Content Locator were the target web site. In either case, the request is handled in the same fashion. If the request is a bypass network web request with a flag indicating content found in cache, it simply replies with the acknowledgement. If the the request is a bypass network web request with a flag indicating content not found in cache, or the request is just an ordinary web request, the Content Locator would perform two levels of content locating described as follows:

1. The Content Locator broadcast content queries on the local network first. If one of the local edge servers has the content, its address would be recorded as source edge server.

2. If none of the local edge server has the requested content, it would broadcast the same queries on its peered networks. The edge server is chosen based on the load percentage and predefined priorities of peered networks. The chosen edge server would be recorded as the source edge server.

At this state, if the request came from one of the local Edge Servers, the Content Locator would reply to the Edge Server. Otherwise, it would reply to the requester. The Content Locator replies to the bypass network web request with the address of chosen source edge server and the acknowledgement. The Content Locator would reply to the ordinary web request with requested content via the Internet since the request was sent by an off bypass network client.

Handling Client Request: All requests are forwarded to the Content Locator. Depending on the method the network administrator chosen to use on the local network, the client request would be handled differently.

Cache-search method:

Three levels of content locating is described as follows:

1. The Content Locator broadcast content queries on the local network first. If one of the local edge servers has the content, its address would be recorded as source edge server.

2. If none of the local edge server has the requested content, it would broadcast the same queries on its peered networks. Assuming the content is found on the peered network, the edge server is chosen based on the load percentage and priority of the local network. The chosen edge server would be recorded as the source edge server.

3. If still not found on the peered local networks, the Content Locator sends the request to the original web server with a flag indicating not found in cache.

At this state, the Content Locator sends the request and a flag, which indicates whether the content was found on the network, to the actual web site. There are two cases in handling the response:

1. If the content is found, the actual web site only confirms the request with an acknowledgement, but no actual data. At this point if the source edge server is not on home local network, the Content Locator picks the least busy edge server at the moment and assignment it as the target edge server for this request. Then the Content Locator notifies both the source and the target edge servers to start the file transfer. The file should be transferred (via the Content Locators or Peering Gateways) in few seconds over the Gigabit network.

2. In the case of content not found anywhere, the actual web site would reply with the acknowledgement and start to transfer data either via the bypass or the Internet depending on the actual web server's network configuration. The Content Locator accepts the acknowledgement and forwards the data to the least busy edge server for caching.

Finally the requested content is available on the same local network as the client. A notice is sent to the Intelligateway/SmartClient to indicate the edge server for streaming services. The Content Locator has done its mission now. Recording the transaction history is described in detail in “Transaction History” section below. The advantage of this method is it effectively makes use of the content on edge servers. The requested content can be retrieved very fast. The disadvantage of this method is that it requires the actual web server understand the flag it's sending. In other word, it assumes the actual web server is on or relate to Moovy MediaWork system. If the actual web server were not, the Content Locator would send a plain web request after time out the first request.

Web-search method:

This method is very simple. The Content Locator does not do any cache search locally. Instead, the Content Locator forwards the original request as a bypass network request to distinguish from original web request. It is purely up to the web server to decide whether transferring the file via the bypass network or the Internet. The disadvantage of this method is that it might waste time to transfer files, which already exist on local edge servers.

Broadcast Queries: The Content Locator broadcast the query on both local network and its peered networks accordingly. When the original request arrived, it would create and broadcast the content query on the local network first. If one of the edge servers has the requested content, it would record its address as source edge server. Otherwise, it would continue to multicast the query on its peered local networks. Upon receive of the query results from each peered network, it would pick the edge server base on the load percentage and predefined priorities of peered networks, and record its address as source edge server. If a content query were received from outside of the local network, it would broadcast the query on the local network. If the content were found on this network, usually only one edge server would contain it. The Content Locator would respond the query with the address of this edge server.

Local Network Information: The status of each Edge Server must be known in order to determine the least busy Edge Server. On a regular basis, the Content Locator pings each Edge Server to ensure it's alive, and receives load status from all Edge Servers. Combining the status of all Edge Servers and traffic load, Content Locator would calculate the load percentage of the local network. The details on how to combine all the factors in a way to reflect real network status are to be researched.

Peered Network Information: The status of each peered network must be known in order to determine the least busy local network. On a regular basis, the Content Locator pings each peered Content Locators to ensure they are still alive, and peered Content Locators sends network status to each other.

Transaction History: When the Content Locator informs the gateway/client, the source edge server, it creates a new transaction record, including account ID, URL, file size, status, and etc. The transaction record is updated according to the streaming status provided by the Intelligateway or SmartClient. The transaction history contains all the transaction records during the user's log on time. This information would be saved on Peering Gateway during log off session.

Handling Failure: If a transaction failure occurs on the Edge Server, the Intelligateway or SmartClient would detect it and inform the Content Locator. The Content Locator parses the status report (failure notice) and updates the transaction record. It then treats it as a regular request and makes the content available on an alternative Edge Server. The content can be either duplicated from the failure Edge Server to the alternative Edge Server or transferred from outside of the local network. The detail of the failure recovery is to be researched.

Overall, the Content Locator supervises individual local network by managing all Edge Servers. It is the gate to the rest of the bypass network and a temperate customer account manager. The most important, it the central processor of all Internet requests, especially for streaming media. The Content Locator two primary functions are locating the content on the network and making the content available to the client.

Edge Server:

The edge server is responsible to transfer the requested content to the client. The server also needs sufficient disk storage in order to cache the recent and frequent accessed files. The Edge Server runs all kinds of streaming server in order to provide streaming services. On regular basis, the edge server sends its status to the Content Locator. A web server can be run on the same machine as the Edge Server. The following is the core functionalities of this component.

Web Caching Service: As many other proxy servers, the Edge Server caches the most recent access data by the client on this local network. Unlike other common cache servers, the Edge Server uses the dynamic caching scheme. Since the interactive movie and similar media file takes enormous storage space, it is crucial to use network cache storage wisely. The content is delivered to the edge server upon the requests and resides in the cache for only short period of time. When the content in the cache is being queried, the cache automatically delays the expiration time if it is about to be deleted from the cache. If the Edge Server were chosen to be the source Edge Server for certain content, the cache would adjust the expiration time accordingly to ensure the content is available to access in the near future.

Streaming Server: All kinds of streaming servers are running on each Edge Server in order to provide various real-time streaming media services to clients. The Edge Server receives the request from SmartClient or IntelliGateway; the content is retrieved from the cache and being prepared on the appropriate streaming server. Then streaming server would start streaming the data to the SmartClient or Intelligateway.

Handling Web Request: The requests arrive at the Edge Server directly from the requester if the Edge Server were the target web site. If the request is a bypass network web request with a flag indicating content found in cache, it simply replies with the acknowledgement. If the request is a bypass network web request with a flag indicating content not found in cache, or the request is just an ordinary web request, the Edge Server forwards the request to Content Locator and expect the address of source Edge Server as reply. The Edge Server replies to the bypass network web request with the address of chosen source edge server and the acknowledgement, and reply to the ordinary web request with requested content via the Internet since the request was sent by an off bypass network client.

Computing Load: This server computes the percentage of load on a regular basis and sends it to Content Locator. This factor can be used to determine the least busy Edge Server on the network. In other words, it helps the Content Locator balancing the load among all Edge Servers.

Handling Query: The Content Locator queries the contents on each Edge Server for each request it received. Therefore, the Edge Server needs to handle the content query efficiently. The Edge Server accepts the content queries and translates them into the cache query so the cache can process it. It translates the cache query results into a language, which is understandable by the Content Locator as well. After all, the query results are sent to the Content Locator. This allows different cache system running on each Edge Server.

Handling Failure: If a transaction failure occurs on the Edge Server, the Content Locator would be informed and have the data ready on an alternative Edge Server. Therefore, the Edge Server must be able to understand the incoming status report, which indicates where the streaming session was interrupted. With this information, it makes the streaming server starts streaming from the interrupted point.

Overall, the Edge Server is the cache server and streaming server. It could be a web server as well depends on the network administrator. Virtually it's on the edge of the CDN bypass network. The Edge Server computes load percentage and translates incoming messages to support the caching and streaming services.

IntelliGateway and Regular Client:

The biggest advantage of this design is that any client machine on Moovy MediaWork can obtain high QoS without changing settings or installing software. The only disadvantage of the IntelliGateway design is that all clients have to be on Moovy MediaWork in order to get the best QoS. If the client is at any unknown network with old fashion gateway, there is no way the client machine can access Moovy MediaWork unless it's running SmartClient. The following is the core functionalities of this component.

Gateway: In additional to normal gateway forwarding function, the IntelliGateway integrates the IntelliNet to allow configuration free access. The client machine can gain access to the QoS anywhere in the CDN bypass network without reconfiguring network setting.

Reporting Status: The Intelligateway checks the status of each opening port for incoming streaming data. If a port times out, it would send the Edge Server a termination notice and close the port. If the streaming session ends maturely, the Intelligateway simply sends Content Locator to confirm the success. Otherwise, it sends a status to Content Locator.

Handling Request: when the client machine initiates a request, IntelliGateway forwards request to the Content Locator and expecting the address of Edge Server for streaming services. Once it obtains the address of the Edge Server, it communicates with it to setup the streaming connection. The Intelligateway provides Content Locator information (such as port number) regarding this connection. Then, the Intelligateway acts like a router to forward the streaming data to the client.

Overall, the Intelligateway is built on top of the IntelliNet described in Section 9. Its primary goals are to ensure quality connection between the clients and Edge Servers, and provide configuration free access for the customers.

SmartClient:

Portion of the IntelliGateway system can be implemented on each individual client machine. The client becomes a SmartClient. Once the client machine has the intelligence, it can move anywhere on the network. For instance a businessperson carries his/her laptop around the world. The laptop is connected to the network running any gateway and network setting. Before it starts any network transaction, it first probes for Content Locator on the network. If a Content Locator response, it would self configure as a client of this network. Otherwise, it would contact its home Peering Gateway to find an available local network. There must be a special IntelliGateway running on this local network in order to accept client request from the Internet. Then the SmartClient would self configure as a client of this IntelliGateway. Any further network request would be same as its home network since then. The following is the core functionalities of this component.

Self-Configuring: When a SmartClient connects to a network, it first sends out a special message searching for a Content Locator on the bypass network. If such server replies, the SmartClient self-configure as a client machine on this local network by setting this server as default Content Locator. Then user can log on/off via the Content Locator as usual. If the SmartClient were not on any CDN bypass network, it would directly communicate with the home Peering Gateway over the Internet and find a nearby local network. The ISP could setup an Intelligateway on selected local network to accept requests from clients on other networks.

Reporting Status: The SmartClient checks the status of each opening for incoming streaming data. If a port were occurred, it would send the Edge Server a termination notice and close the port. Mean time, it sends a status to Content Locator. If the streaming session ends maturely, SmartClient simply sends Content Locator to confirm the success.

Handling Request: when the user initiates a request, SmartClient sends the request to the Content Locator and expecting the address of Edge Server for streaming services. Once it obtains the address of Edge Server, it communicates with the Edge Server to setup the streaming connection. The SmartClient provides Content Locator information (such as port number) regarding this connection. Then, the data would be slowly streamed to this machine.

Overall, the SmartClient is design to be an anti-Intelligateway system. The machine running SmartClient can be taken everywhere even outside the CDN bypass network. In other words, the customer can truly have access to QoS anywhere any time.

Details of each component and their functions would be given in section 6. The next section gives few use cases to demonstrate how the system works under different circumstances.

### USE CASES

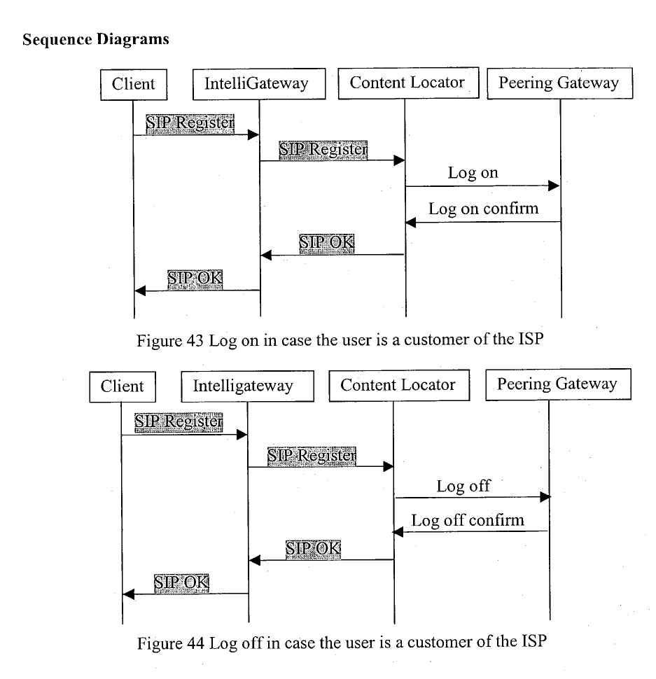

This section gives the descriptions for the major situations. Only the sequences of communications are presented in FIGS. 43 to 54. In other words, the actual messaging between components is not shown.

User Log On and Log Off

When a user logs on the network, the log on/off information is passed to the Peering Gateway for validation. Three cases are described as the following.

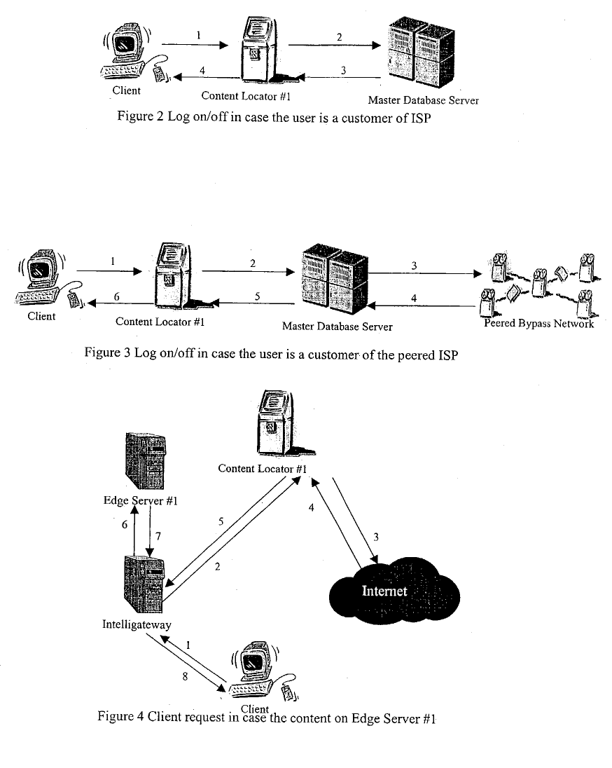

Case 1: The User is a Customer of the ISP (FIG. 2)

Log On:

1. The user log on information is sent to the Content Locator.

2. The user log on information is sent to the Peering Gateway for validation.

3. The Master Database validates the account. If the information is valid, some account related information is sent to the Content Locator. Otherwise, it replies with an error message.

4. Some kind of confirmation is sent to the client based on the Peering Gateway's response. The account information would be entered into a local online database.

Log Off:

1. The log off signal is sent to the Content Locator along with the user ID.

2. The Content Locator validates the ID with the existing local account and packs the transaction records and updated account information. All the data relate to this user is sent to the Peering Gateway.

3. Upon the status of the Peering Gateway updating the main database, it sends a notice to the Content Locator.

4. If update is successful, the Content Locator delete the records in the local database and send a confirmation to the client. Otherwise, it replies to the clients with an error message. The records are remaining on the database. On daily bases, each Content Locator synchronizes its data with the Peering Gateway and clears the online database.

Case 2: The User is a Customer of the Peered ISP (FIG. 3)

Log On:

1. The user log on information is sent to the Content Locator.

2. The user log on information is sent to the Peering Gateway for validation.

3. Since the user account is from a peering network, the Peering Gateway forwards the information the appropriate Peering Gateway on the foreign network for validation.

4. The peering Master Database validates the account. If the information is valid, some account related information is sent to the Content Locator. Otherwise, it replies with an error message.

5. The Master Database forwards the confirmation to the Content Locator.

6. Some kind of confirmation is sent to the client based on the Peering Gateway's response. The account information would be entered into a local online database.

Log Off:

1. The log off signal is sent to the Content Locator along with the user ID.

2. The Content Locator validates the ID with the existing local account and packs the transaction records and updated account information. All the data relate to this user is sent to the Peering Gateway.

3. Since the user account is from a peering network, the Peering Gateway forwards the information the appropriate Peering Gateway on the foreign network for validation.

4. Upon the status of the peering Peering Gateway updating the main database, it sends a notice to the Peering Gateway.

5. The Master Database forwards the confirmation to the Content Locator.

6. If update is successful, the Content Locator delete the records in the local database and send a confirmation to the client. Otherwise, it replies to the clients with an error message. The records are remaining on the database. On daily bases, each Content Locator synchronizes its data with the Peering Gateway and clears the online database.

Case 3: The User is not a Valid Customer on Any Network

In this case, the Content Locator would reply with an error message. The user may not have access to the Internet via the CDN bypass network.

Client Request Handling

When a user initiates a streaming media request, there are four cases. They are described as the following. The following cases would be considered only if cache-search method were employed on this local network. The web-search method rely the web server to do the content locating.

Case 1: Content is on the “Closest” Edge Server (FIG. 4)

1. The client initiates the request. The request is send to the IntelliGateway as all Internet requests go through the network gateway.

2. The IntelliGateway forwards the request to the Content Locator and expecting it reply with a list of Edge Servers containing the requested content.

3. The Content Locator broadcast the query on the network. The Edge Servers, which contains the content, would reply. The Content Locator generates a list of Edge Server who replied and append to the request to indicate content found locally. The Content Locator sends the original request to the actual web server along with a flag to indicate that the content is found on the bypass network. Then it is waiting for acknowledgment from the web server.

4. Since the content is found on the bypass network, there is no need for the web server to prepare data transformation. The web server verifies the request and sends an acknowledgment to allow the content being viewed.

4. The Content Locator receives the acknowledgment and sends the request received earlier back to the Content Locator.

5. The Content Locator forwards the request to the IntelliGateway. In fact, the IntelliGateway received the client's original request and a list of Edge Server containing the content.

6. The IntelliGateway would contact the “closest” Edge Server in the list at the moment and ask for the content.

7. The Edge Server prepares the data and start to stream the data to the IntelliGateway.

8. Finally, the IntelliGateway forwards the streaming data to the original client. While the client is waiting for the connection being setup, the IntelliGateway could play some commercial to fill the gap.

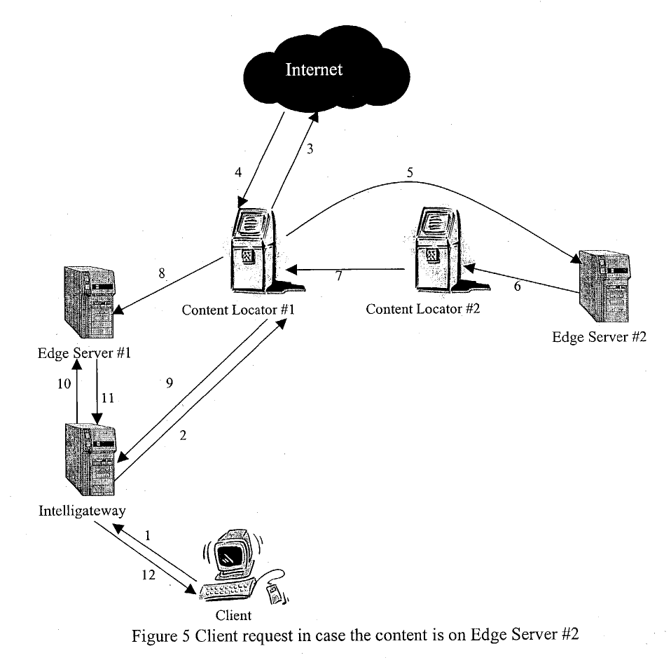

Case 2: Content is Found on the Bypass Network (FIG. 5)

1. The client initiates the request. The request is send to the IntelliGateway as all Internet requests go through the network gateway.

2. The IntelliGateway forwards the request to the Content Locator and expecting it reply with a list of Edge Servers containing the requested content.

3. The Content Locator broadcast the query on the network. No Edge Server would reply to the broadcast since none contains the requested content. The original request is multicast on the peering local networks. Upon receive of the query, the peered Content Locators query its network and reply with address of Edge Servers containing the content. The Content Locator choose the source Edge Server base on the load percentage and priority of the peering local network. The Content Locator sends the original request to the actual web server along with a flag to indicate that the content is found on the bypass network. Then it is waiting for acknowledgment from the web server.

4. Since the content is found on the bypass network, there is no need for the web server to prepare data transformation. The web server verifies the request and sends an acknowledgment to allow the content being viewed.

5. The Content Locator receives the acknowledgment and selects the least busy edge server as the target edge server. It then informs the source Edge Server the acknowledgment and the address of target edge server.

6. The source Edge Server prepares the data and starts the transaction.

7. The peered Content Locator forwards the data to the Content Locator.

8. The Content Locator forwards the data to the pre-selected Edge Server.

9. The Content Locator replies the request to the IntelliGateway. In fact, the IntelliGateway received the client's original request and the address of Edge Server containing the content now.

10. The IntelliGateway would contact the Edge Server and ask for the content

11. The Edge Server prepares the data and start to stream the data to the IntelliGateway.

12. Finally, the IntelliGateway forwards the streaming data to the original client. While the client is waiting for the connection being setup, the IntelliGateway could play some commercial to fill the gap.

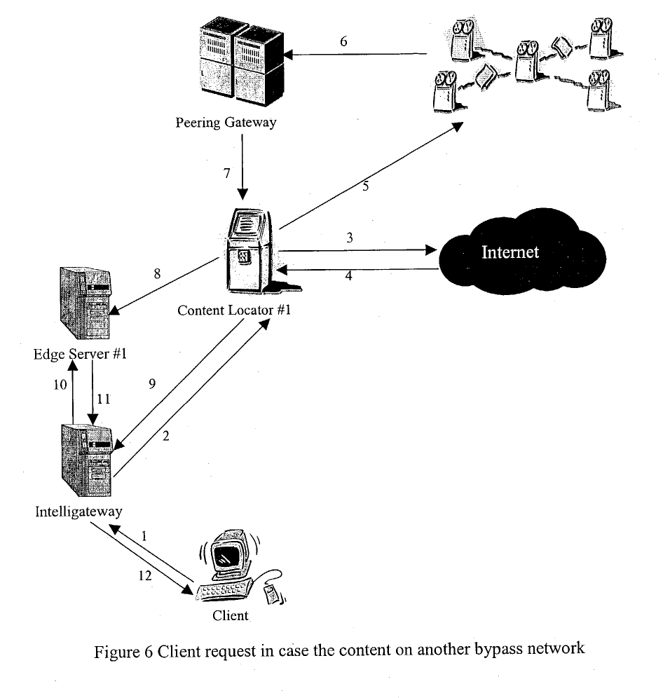

Case 3: Content is on Peered Local Network on Other Bypass Network (FIG. 6)

1. The client initiates the request. The request is send to the IntelliGateway as all Internet requests go through the network gateway.

2. The IntelliGateway forwards the request to the Content Locator and expecting it reply with a list of Edge Servers containing the requested content.

3. The Content Locator broadcast the query on the network. No Edge Server would reply to the broadcast since none contains the requested content. The original request is multicast on the peering local networks. Upon receive of the query, the peered Content Locators query its network and reply with address of Edge Servers containing the content. The Content Locator choose the source Edge Server base on the load percentage and priority of the peering local network. The Content Locator sends the original request to the actual web server along with a flag to indicate that the content is found on the bypass network. Then it is waiting for acknowledgment from the web server.

4. Since the content is found on the bypass network, there is no need for the web server to prepare data transformation. The web server verifies the request and sends an acknowledgment to allow the content being viewed.

5. The Content Locator receives the acknowledgment and selects the least busy edge server as the target edge server. It then informs the source Edge Server the acknowledgment and the address of target edge server.

6. The source Edge Server prepares the data and starts the transaction.

7. The Peering Gateway forwards the data to the Content Locator.

8. The Content Locator forwards the data to the pre-selected Edge Server.

9. The Content Locator replies the request to the IntelliGateway. In fact, the IntelliGateway received the client's original request and the address of Edge Server containing the content now.

10. The IntelliGateway would contact the Edge Server and ask for the content

11. The Edge Server prepares the data and start to stream the data to the IntelliGateway.

12. Finally, the IntelliGateway forwards the streaming data to the original client. While the client is waiting for the connection being setup, the IntelliGateway could play some commercial to fill the gap.

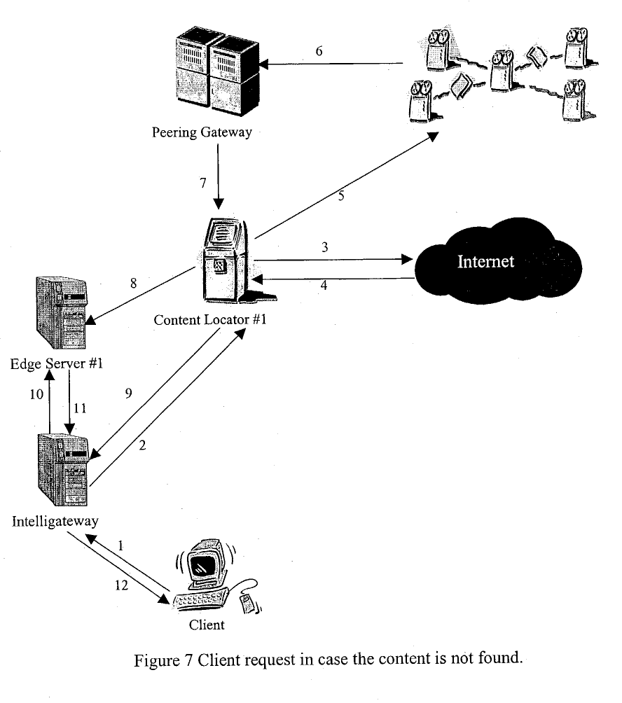

Case 4: Content is not Found (FIG. 7)

1. The client initiates the request. The request is send to the IntelliGateway as all Internet requests go through the network gateway.

2. The IntelliGateway forwards the request to the Content Locator and expecting it reply with a list of Edge Servers containing the requested content.

3. The Content Locator broadcast the query on the network. No Edge Server would reply to the broadcast since none contains the requested content. The original request would be multicast on the peered local networks. In this case, none of the peered local network has the content either.

4. The Content Locator sends the original request to the actual web server along with a flag to indicate that the content is not found on the bypass network. Then it is waiting for acknowledgment from the web server.

5. If the web server is on or relate to the bypass network system, an acknowledgment would be sent along with an address of source Edge Server.

6. The source Edge Server prepares the data and starts the transaction.

7. The Peering Gateway forwards the data to the Content Locator.

8. The Content Locator forwards the data to the pre-selected Edge Server.

9. The Content Locator replies the request to the IntelliGateway. In fact, the IntelliGateway received the client's original request and the address of Edge Server containing the content now.

10. The IntelliGateway would contact the Edge Server and ask for the content

11. The Edge Server prepares the data and start to stream the data to the IntelliGateway.

12. Finally, the IntelliGateway forwards the streaming data to the original client. While the client is waiting for the connection being setup, the IntelliGateway could play some commercial to fill the gap.

Note: If the web server is not related to the bypass network system at all, eventually the request would time out and the Content Locator would forward the ordinary web request to the web server. The web content would come back via the Internet to the IntelliGateway.

Web Request Handling

The request could arrive at either the Content Locator or the Edge Server since both of them can run a web server. In either case, the request would be handled in similar fashion. The following cases would be considered regardless the searching method employed at the client side. The web-search method rely the web server to do the content locating. This section assumes the Edge Server is the web server. In case of the Content Locator is the web server; the step where the Edge Server forwards the request to the Content Locator can be eliminated. From case 1 to case 4, assuming the request was from a client on the bypass network system. Case 5 demonstrate how an off bypass network request would be handled.

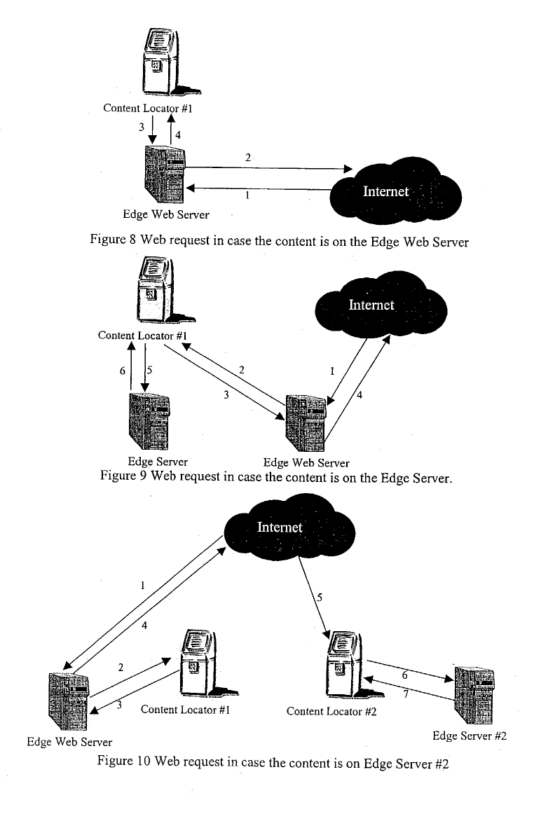

Case 1: Content is Found on the Web Server (FIG. 8)

1. The request arrives at the Edge Web Server from the Internet.

2. The Edge Web Server realize the content is in its cache. Therefore the Edge Web Server reply to the request with its address as the source Edge Server.

3. The target network informs the Edge Web Server the address of target Edge Server.

4. Edge Web Server starts to transfer the data via its Content Locator to the target Edge Server.

Case 2: Content is on the Other Edge Server of the Local Network (FIG. 9)

1. The request arrives at the Edge Web Server from the Internet.

2. The Edge Web Server realize the content is not in its cache. The Edge Web Server forwards the request to its Content Locator to do further searching.

3. The Content Locator broadcast the request on the local network. In this case, one Edge Server response to the query. The Content Locator inform the Edge Web Server the address of the Edge Server containing the content.

4. The Edge Web Server reply to the request with the address of the source Edge Server.

5. The target network informs the Edge Web Server the address of target Edge Server.

6. Edge Web Server starts to transfer the data via its Content Locator to the target Edge Server.

Case 3: Content is on the Peered Local Network (FIG. 10)

1. The request arrives at the Edge Web Server from the Internet.

2. The Edge Web Server realize the content is not in its cache. The Edge Web Server forwards the request to its Content Locator to do further searching.

3. The Content Locator broadcast the request on the local network. In this case, no Edge Server response to the query. The Content Locator then multicast the request on the peered local networks. In this case, one or more peered local networks response to the query. The Content Locator choses the source Edge Server base on load percentage and priority of the peered local networks. At last, it informs the Edge Web Server the address of the Edge Server containing the content.

4. The Edge Web Server reply to the request with the address of the source Edge Server.

5. The target network informs the Edge Web Server the address of target Edge Server.

6. The source Content Locator forwards the message the appropriate Edge Server.

7. Edge Web Server starts to transfer the data via its Content Locator to the target Edge Server.

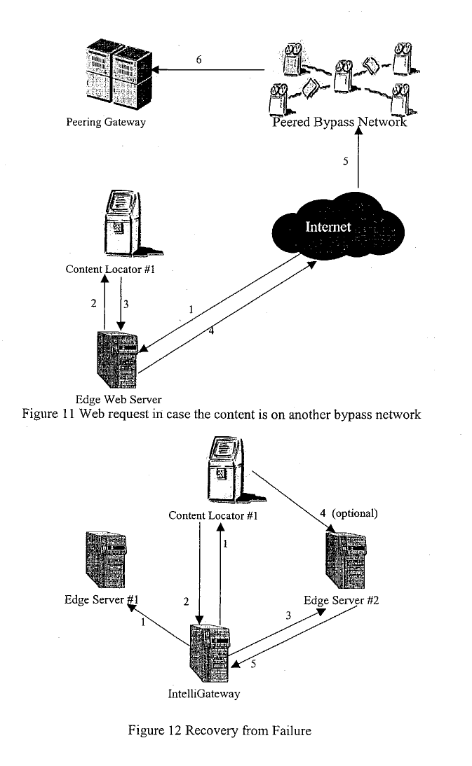

Case 4: Content is on Peered Local Network on Other Bypass Network (FIG. 11)

1. The request arrives at the Edge Web Server from the Internet.

2. The Edge Web Server realize the content is not in its cache. The Edge Web Server forwards the request to its Content Locator to do further searching.

3. The Content Locator broadcast the request on the local network. In this case, no Edge Server response to the query. The Content Locator then multicast the request on the peered local networks. In this case, one or more peered local networks response to the query. The Content Locator choses the source Edge Server base on load percentage and priority of the peered local networks. At last, it informs the Edge Web Server the address of the Edge Server containing the content. This case is different from the previous case since the peered local network in on a peered bypass network instead of home bypass network.

4. The Edge Web Server reply to the request with the address of the source Edge Server.

5. The target network informs the Edge Web Server the address of target Edge Server.

7. Edge Web Server starts to transfer the data via the Peering Gateway to the target Edge Server. Within the bypass network, data is transferred in the same as step 6 and 7 in the previous case.

Case 5: Handling Request From Off Bypass Network Client

In this case, the Edge Web Server would do the exact content locating as in case 1 to 4, and then reroute the request to the appropriate source edge server. The source edge server would treat it as ordinary web request and streaming the data to the client via the Internet. In other words, it the client is not subscribed to the bypass network system, he or she would not receive this high quality end result.

Recover from Failure (common to both IntelliGateway and SmartClient) (FIG. 12)

1. The IntelliGateway timeout the transaction from Edge Server #1. It sends a termination notice to this Edge Server, and a failure notice to the Content Locator along with the content ID and status.

2. The Content Locator do whatever it is appropriate to make the content available on another Edge Server, then inform the IntelliGateway the new Edge Server to contact.

3. The IntelliGateway would contact the Edge Server and ask for the content

4. The Edge Server prepares the data and start to stream the data to the IntelliGateway. While the IntelliGateway is waiting for content, the IntelliGateway could play some commercial to fill the gap.

### SEQUENCE FIGURES

This section gives the flow of messaging for the major situations. The messages interchanged between each component would be shown in each case sequence diagram (FIGS. 43 to 54).

The [symbol] indicates the messages sending via the Internet link. The ---> indicates the data sending via the Gigabit link. The message with gray background color is using other protocols than the Media Extraction Access protocol.

User Log On and Log Off

When a user logs on the network, the log on/off information is passed to the Peering Gateway for validation. Three cases are described as the following.

Case 1: The User is a Customer of the ISP

This section describes the message sequence for use case 4.1.1.

Logging on: (FIG. 43)

Logging off: (FIG. 44)

Case 2: The User is a Customer of the Peered ISP.

This section describes the message sequence for use case 4.1.2.

Logging on: (FIG. 45)

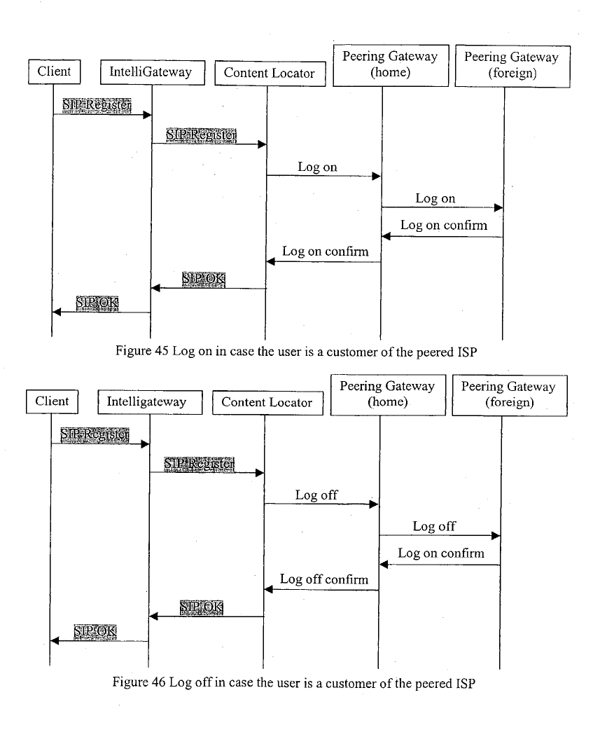

Logging off: (FIG. 46)

Case 3: The uUer is Not a Valid Customer on Any Network.

In this case, the user would not receive a SIP OK message.

Further Clarifications

The logon and logoff procedures work nearly identical to each other. The only thing is that it may be a bit confusing as to what is actually going on during one of these processes. This section will hopefully give a complete and better understanding of this.

Logging on:

1) When a client wants to logon, the information is first sent to the Intelli-Gateway. The logon message is forwarded on to the local Content Locator from here.

2) The Content Locator recognizes this message as a logon message by analyzing the information on that message. Then the message enters the Content Locator's logon handler. In here the logon handler assigns a new process id and appends to the message. Returning to the ‘main’ function of the Content Locator, this updated message is now passed on to it's Peering Gateway.

3) The Peering Gateway recognizes the logon message with the getTask( ) function and there for enters it's logon handler. In this logon handler the user is checked against the Peering Gateway's database and 3 possible outcomes can occur.

i) The user is found and validated. If so, user information is fetched and returned to the ‘main’ function of the Peering Gateway. From here that user information is sent back to the source Content Locator that forwarded the logon message and this process is continued to step 4)

ii) The user is NOT found. In this case, the user information is checked to see if they could exist on another Peering Gateway. If so then the logon message is passed on to that particular Peering Gateway. An empty string is returned to the ‘main’ function of this current Peering Gateway application so that an empty response is sent back to the content locator.

Now the Peering Gateway of where the user exists receives this message and enters its logon handler. It finds the user and validates them thus returning the user information it has retrieved back to the ‘main’ function. This information plus the “logon confirm” string is sent back to the sender of the message (IE: the first Peering Gateway).

The first Peering Gateway sees this “logon confirm” string and forwards the message back to the Content Locator. This destination will be found with the “getRequestLocal( )” function. The process continues at step 4) from here.

iii) The user doesn't exist anywhere and an error message is returned to the ‘main’ function which is then relayed back to the Content Locator and the process continues at step 4).

4) The Content Locator now receives a message along with a string that says “logon confirm”. It is then the Content Locator will add this user to its list of active clients if successful and sends back some kind of confirmation to the client. Otherwise it just sends back an error notification to the client

The Logoff process is nearly identical to the Logon procedure aside from some minor cosmetic differences.

Client Request Handling

The following cases would be considered only if cache-search method were employed on this local network. The web-search method rely the web server to do the content locating.

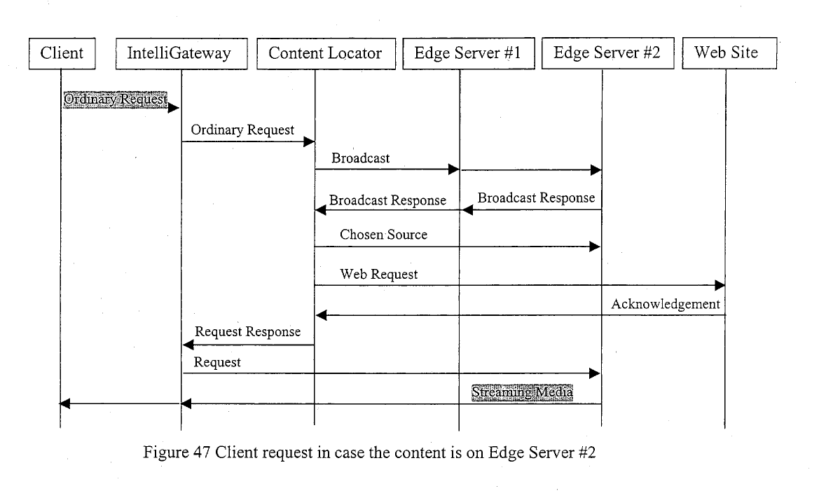

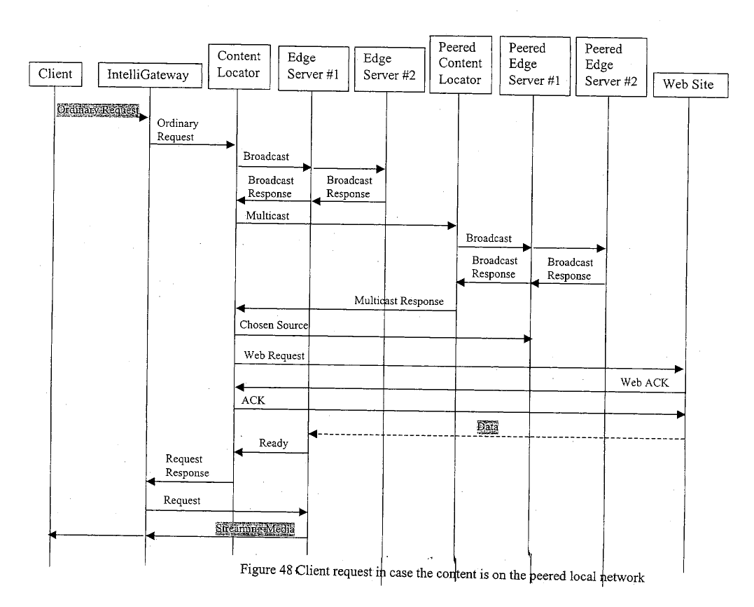

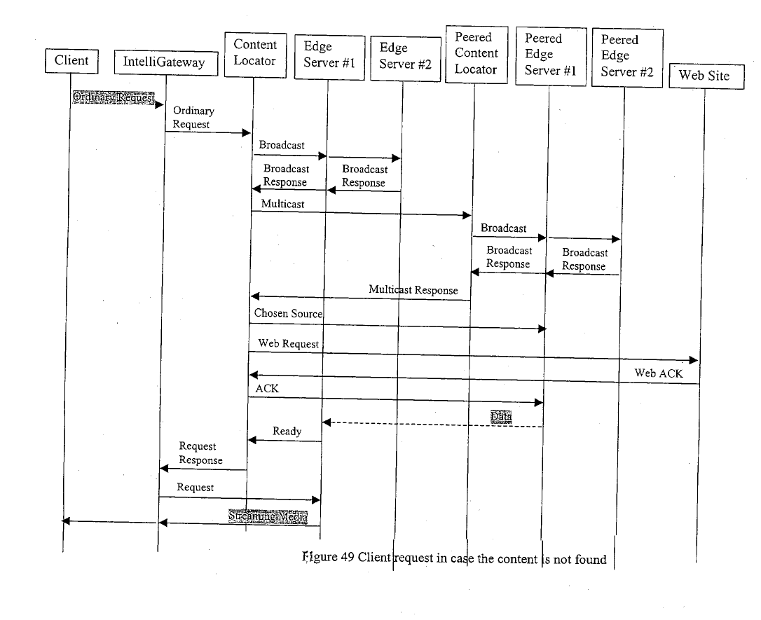

Case 1: Content is on the “Closest” Edge Server (FIG. 47)

This section describes the message sequence for use case 4.2.1.

1) Ordinary Request: The request is just forwarded to the Intelli-Gateway.

2) Ordinary Request: The request is forwarded to the Content Locator which is picked up in its main function with: if(task==“”), and the function requestHandler( ) is called.

3) Broadcast: In the requestHandler( ) function, a local broadcast is sent out the Edge Servers with: localBroadcast( ).

4) Broadcast Response: A message with “broadcast response” in the header is sent back to the Content Locator from the Edge Servers. The Content Locator picks these responses up with: if(task==“broadcast response”). Once all the Edge Servers have responded, or a time out limit is reached, the function: responseHandler( ) is called.

5) Chosen Source: In the responseHandler( ), the else statement is taken and we go into the request vector that has a list of responded Edge Servers, we pick the Edge Server that contains the content with the function: chooser( ), and set the source address of that server. The function requestHandler2( ) is then called.

6) Web Request: In requestHandler2( ), we take the first: if(task==“broadcast response”) and in this case, since the content IS found, we don't need to do a multicast. Instead, we send a message to the Edge Server telling it to make the content available. As well, send a message to the web server indicating that we found the content locally.

7) Acknowledgement: The web server will respond with “web ack” in its message. The Content Locator will pickup on this with: if (task ==“web ack”), and call webresponseHandler( ).

8) Request Response: Inside webresponseHandler( ), both the “if” and “else” statements are skipped because we found the content locally and with: send(X,Y,Z), we inform the Intelli-Gateway that we are ready for final transmission.

9) Request: On the Intelli-Gateway, it calls the ackHandler to create the final request to the Edge Server.

10) Streaming Media: On the Edge Server, the requestHandler is called, connections are made and streaming begins to the end user.

Case 2: Content is Found on the Peered Local Network (FIG. 48)

This section describes the message sequence for use case 4.2.2 and 4.2.3. The Content Locator multicasts the request on the peered local networks regardless the bypass network location. In other words, the peered local networks might be either on the same bypass network as the Content Locator or on the peered bypass networks. Due to the limitation of page setting, only one peered local network is shown in the figure. However, the message sequence is still the same.

1) Ordinary Request: Same as 1 in case 1.

2) Ordinary Request: Same as 2 in case 1.

3) Broadcast: Same as 3 in case 1.

4) Broadcast Response: Same as 4 in case 1.

5) Multicast: In the responseHandler( ), the else statement is taken and we go into the request vector that has a list of responded Edge Servers, we find that the no onein the list has our content with the function: chooser( ), and set the source to NULL. The function requestHandler2( ) is then called.

In requestHandler2( ), we go into: if (task==“broadcast response”) and since setSource was NULL, then getSource( ) will be too. There for we send out a multicast request to all the peered networks.

The “other” Content Locators will pick up this multicast with: if (task==“multitcast”), and enter their requestHandler( ).

6) Broadcast: Same as 3 in case 1.

7) Broadcast Response: Same as 4 in case 1.

8) Multicast Response: Inside our responseHandler( ), we take the first “if” statement:

if(curr_request.isPeer( )) because the original response comes from a peered network. We then use the send( ) function to send a “multicast response” message back to the original Content Locator.

9) Chosen Source: Now back in the original Content Locator, the statement: if(task==“multicast response”) is entered. Once a response from all the peered networks come in, or a time out, we enter the responseHandler( ) once again. In the responseHandler( ), we enter the else statement, and from the list of requests, for the particular request a list of Edge Servers on all the peered the networks will exist. The chooser( )function will pick the best, closest, fastest Edges Server based on load percentages. The source is then set with this address and requestHandler2( ) is called.

In requestHandler2( ), we enter the statement: if(task==“multicast response”), and we send a request to the Edge Server containing the content. As well as a web ack.

10) Web Request: Same as 6 in case 1.

11) Web ACK: Same as 7 in case 1.

12) ACK: Inside webresponseHandler( ), We find the “lightest load” local Edge Server and set it to “target”. Then the first “if” statement is entered and a message is sent to the “other” Edge Server with “target” as input.

13) Data: This will tell the “other” Edge Server to start streaming data to the local Edge Server.

14) Ready: (this function is still shady): Once streaming is complete the last line in webresponsHandler( ) is called and a message to the Intelli-Gateway is sent to initiate content transfer to client.

15) Request Response: Same as 8 in case 1.

16) Request: Same as 9 in case 1.

17) Streaming Media: Same as 10 in case 1.

Case 3: Content is Not Found (FIG. 49)

This section describes the message sequence for use case 4.2.4.

1) Ordinary Request: Same as 1 in case 2.

2) Ordinary Request: Same as 2 in case 2.

3) Broadcast: Same as 3 in case 2.

4) Broadcast Response: Same as 4 in case 2.

5) Multicast: Same as 5 in case 2.

6) Broadcast: Same as 6 in case 2.

7) Broadcast Response: Same as 7 in case 2.

8) Multicast Response: Same as 8 in case 2.

9) Chosen Source: Now back in the original Content Locator, the statement: if(task==“multicast response”) is entered. Once a response from all the peered networks come in, or a time out, we enter the responseHandler( ) once again. In the responseHandler( ), we enter the else statement, and from the list of requests, for the particular request a list of Edge Servers on all the peered the networks will be empty. Thus setSource( ) will be set to NULL. requestHandler2( )is then called.

10) Web Request: In requestHandler2( ), the statement: if (task==“multicast response”) is taken, and the first condition is entered after because getSource( ) will return NULL because it was set to null in previous step. The function then sends out a message to the web server indicating “false” meaning that the content couldn't be found.

11) Web ACK: The web server sends an “web ack” message back to the Content Locator. The main function picks this up and enters webresponseHandler( ).

12) ACK: In the webresponseHandler( ), the else statement is taken since the content cannot be found. Here we send an “ACK” message to the web server, this time with a target “lightest load” local Edge Server.

13) Data: This is where the web server will begin streaming content to the local Edge Server.

14) Ready: (this function is still shady): Same as 14 in case 2.

15) Request Response: Same as 15 in case 2.

16) Request: Same as 16 in case 2.

17) Streaming Media: Same as 10 in case 1.

Web Request Handling

The request could arrive at either the Content Locator or the Edge Server since both of them can run a web server. The following cases would be considered regardless the searching method employed at the client side. This section assumes the Edge Server is the web server. In case of the Content Locator is the web server; the step where the Edge Server forwards the request to the Content Locator can be eliminated.

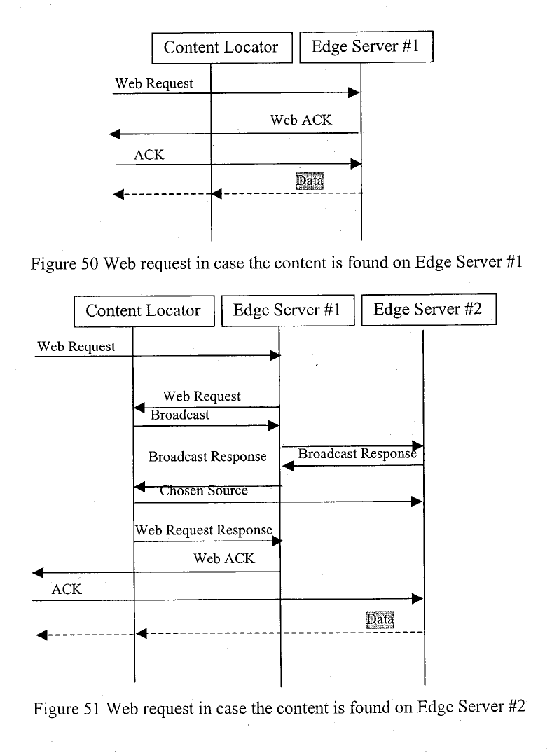

Case 1: Content is Found on the Web Server (FIG. 50)

This section describes the message sequence for use case 4.3.1.

Case 2: Content is on the Other Edge Server of the Local Network (FIG. 51)

This section describes the message sequence for use case 4.3.2.

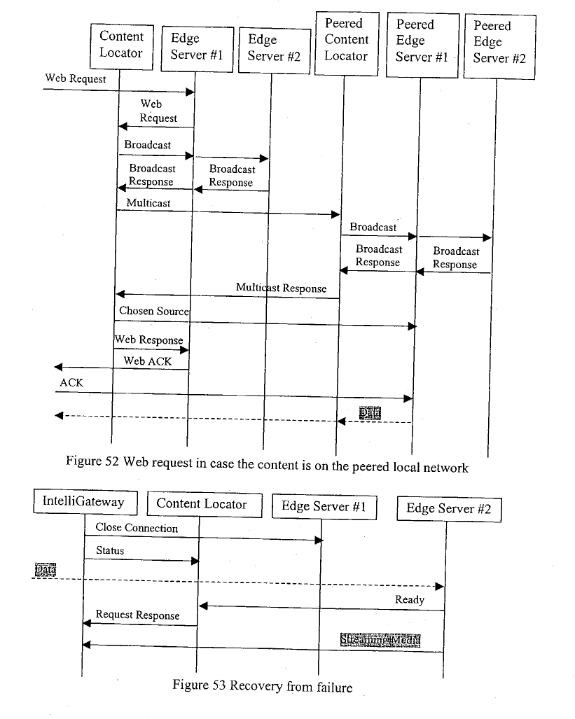

Case 3: Content is on the Peered Local Network (FIG. 52)

This section describes the message sequence for use case 4.3.3 and 4.3.4. The Content Locator multicasts the request on the peered local networks regardless the bypass network location. In other words, the peered local networks might be either on the same bypass network as the Content Locator or on the peered bypass networks. Due to the limitation of page setting, only one peered local network is shown in the Figure. However, the message sequence is still the same.

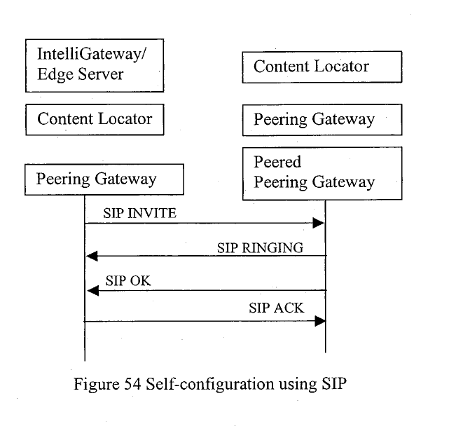

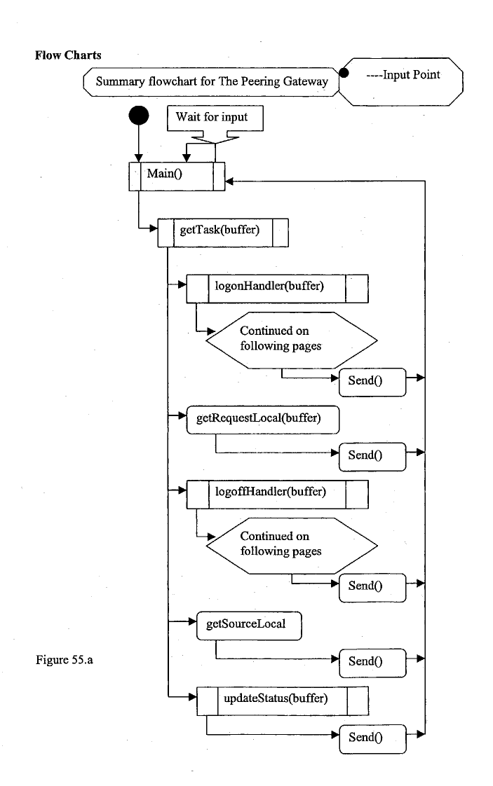

Recover from Failure (Common to both IntelliGateway and SmartClient) (FIG. 53)

This section describes the message sequence for use case 4.4.

Initialization on startup (FIG. 54)

On startup of each component of the system, the component uses SIP to inform its peers and upper level component about its existence. The session is described in the following sequence Figure. The detail of each message could be found in RFC 2543, “SIP: Session Initiation Protocol”.

### DETAIL DESCRIPTIONS

Peering Gateway:

The Peering Gateway maintains the user account databases and handles requests as necessary. The machine running Peering Gateway must have three network interfaces, one for Internet connection, one for peer connection, and one for internal bypass network. The interfaces are named as follows:

1. Signaling interface: This interface has regular Internet connection. The Peering Gateway communicates with the peering networks and Content Locators through this interface in order to avoid congesting the Gigabit bypass network.

2. Peering interface: This interface has Gigabit connection, and connects to all the Peering Gateways on the peering networks. Peering Gateway accepts and sends requested content through this interface in order to provide fast file transfer rate.

3. Bypass interface: This interface has Gigabit connection as well, and connects to all the Content Locators on the bypass network. Peering Gateway accepts and sends requested content through this interface in order to provide fast file transfer rate.

All signaling are handled by signaling interface. The other two interfaces are reserved for data transactions only. The data structures and functions of Peering Gateway is described in detail in this section.

Responsibilities

All the Peering Gateway does is check for people logging on, logging off and getting a status update of Content Locators. It appears that the Peering Gateway contains a list of bypass networks, each with a list of local networks and in that contains a list of requests. The Peering Gateway consists of 5 primary functions and a secondary hidden function. They will be build using the UDP protocol and utilize broadcasting/multicasting techniques. All functions are built from scratch. The code will eventually be encapsulated in OOP style.

The 4 Primary Responsibilities are:

1) Logging someone on. This is implemented with logonHandler(buffer)

2) Confirming A logon. This function is only used when the client exists on a peered bypass network. This is implemented with: getRequestLocal(buffer)

3) Logging a person off. This is implemented with: logoffHandler(buffer)

4) Confirming someone has logged off. This function is also used only when the client exists on a peered bypass network. This is implemented with: getSourceLocal(buffer)

5) Status updating for the appropriate local network. This is what is called whenever a Content Locator on this network sends in a report. The report is parsed and the status of the local network is updated in the Peering Gateway's list of local networks. This is implemented with: updateStatus(buffer)

The Secondary hidden responsibility works as follows:

This is a hidden function that doesn't necessarily occur at the application level.

The function is to just forward any incoming content to the appropriate local network.

As described above, the Peering Gateways only directly interacts with its local Content Locators and other neighboring Peering Gateways.

In accompany to the main code and functions are five classes which contain the necessary data in an organized manner. These classes of which will be described in detail towards the end of this document.

Data Structure

Account Information (Algorithm 1): This class is used to hold the log on and log off information. The methods in this class are design to provide easy access to the offline user account database. This is an object created with logonHandler( ) and logoffHandler( ). It is used to contain all information about the user trying to access the system.

Transaction information (Algorithm 2): This class holds the transaction records of each account. For every existing account object there will be a transaction object as well. The transaction class seems to track client usage. This is probably used for billing purposes. This class holds the transaction records of each account.

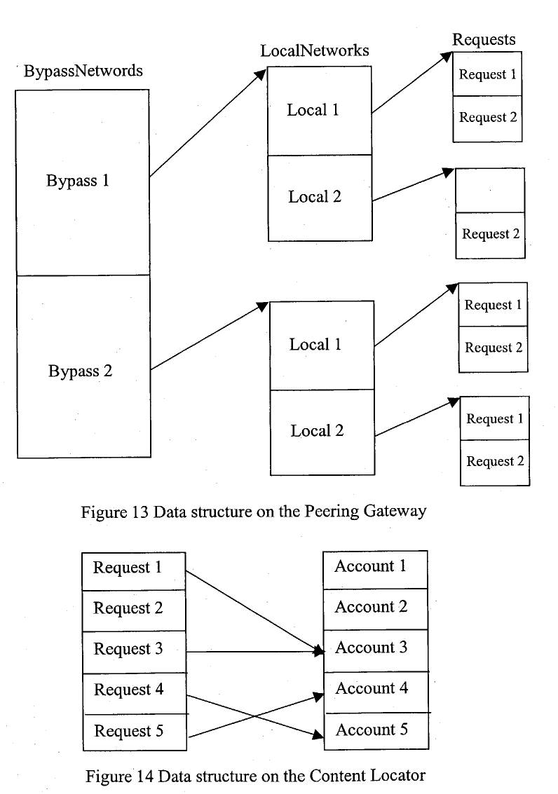

Request list (Algorithm 3): This is a list of all requests that are currently handled by the Peering Gateway. The request list is an array of objects of class Request. The following data structures (FIG. 13) represent the complete list.

Vector BypassNetworks;

/* a vector of LocalNetworks on same bypass network.*/

Vector LocalNetworks;

/* a vector of Requests handled by the same Content Locator*/

Vector Requests; /* a vector of Requests */

This class is initialized by the Content Locator and by the Peering Gateway. A list of all requests that are currently handled by the Peering Gateway are composed of this object.

All_Networks (Algorithm 4): This is a vector of LocalNetwork. This vector is used to maintain the current status of each local network. This object is created in the updateStatus( ) function. A vector of this object is held. The vector is used to maintain the current status of each current network.

All_Bypasses (Algorithm 5): This is a vector of BypassNetwork. This vector is used to store the predefined priority of each Bypass network. There exists a vector of Bypass Network. This vector is used to store the predefined priority of each Bypass Network.

Main Method

The main method (Algorithm 6) accepting incoming packets and calling the appropriate method base on the content of the packets. This will be a never-ending loop constantly waiting for broadcast messages. The Peering Gateway will respond accordingly to every message that it receives.

Log On

When the Peering Gateway receives a message from one of it's Content Locators that a user is wanting to logon, it extracts information from the message and does a validation check. Three cases can occur, user exists on this PG (Peering Gateway), user exists on a neighboring PG (there for the message is forwarded on to the neighboring PG, or user doesn't exist at all.

The Peering Gateway will receive the following from the Content Locator:

Task: log on;

ID: <userid>;

Network: <network name>;

Password: <########>;

UID: <Universal Process ID>;

Upon receiving and processing, the following output must be generated and sent back to the Content Locator:

Task: log on confirm;

UID: <Universal Process ID>;

Status: <status>;

ID: <userid>;

Network: <network name>;

Other account information: /* This field is left to provide more information for future development. */

Process (Algorithm 7):

Upon arrival of the log on information, the Peering Gateway checks the network name against its own network name first. If the user account were from a foreign bypass network, which has peering agreement, the account would be sent to the foreign network for validation. After the validation, account related information would be transferred to the Content Locator that the user is currently connecting to.

Log Off

When the Peering Gateway receives a message from one of it's Content Locators that a user is wanting to logoff, it extracts information from the message and does a check. Three cases can occur, user is currently logged on this PG (Peering Gateway), user is logged on a neighboring PG (there for the message is forwarded on to the neighboring PG, or user cannot be found to be logged off.

The Peering Gateway will receive the following from the Content Locator:

Task: log off;

ID: <userid>;

Network: <network name>;

Account information: <object of Account class>;

Upon receiving and processing, the following output must be generated

Upon receiving and processing, the following output must be generated and sent back to the Content Locator:

Task: log off confirm;

UID: <#>@<local network name>@<bypass network name>;

Status: <status>;

ID: <userid>;

Network: <network name>;

Process (Algorithm 8):

Upon arrival of the log off information, the Peering Gateway checks the network name against its own network name first. If the user account belongs to a peered bypass network, the data would be sent to this network for update. A confirmation would be send to the Content Locator that the user is currently connected to.

Bypass Network Information

On a regular basis, the new status of each local network would arrive. This function is called from the Content Locators whenever one of the Locators has completed a status check and sends the report to the Peering Gateway. The Gateway then takes this information and enters it into its list of local networks. Thus always having the most up to date status of all its local networks.

The Peering Gateway will receive the following from most likely the Content Locators

Task: status;

Network: <local network name>;

ID: <ID assigned by Peering Gateway>;

Load: <load percentage>;

Upon receiving and processing, the following output must be generated

None

Process (Algorithm 9):

The new status would be updated accordingly.

Other Global Methods:

The Algorithm codes for the following methods are presented since they are very trivial and straightforward to implement.

/* This verifies if the given network name is a member of peering networks. */ Boolean isPeer(String <network name>);

/* This verifies if the given IP address is the Peering Gateway for one of the peering networks. */

Boolean isPeer(String <IP address>);

/* This parses out the Task field in the packet. */

String getTask(String buffer);

/* This parses out the Local Network name in the UID field of the packet. */

String getRequestLocal(String buffer);

/* This parses out the Bypass Network name in the UID field of the packet. */

String getRequestNetwork(String buffer);

/* This sends the given data to the target. */

Boolean send (String data, sockaddr_in target);

/* This gets the IP address of the Peering Gateway for the given bypass network name. */

sockaddr_in getPeerGateway(String <network name>);

/* This method generates a list of all active local networks. */

Vector getLocalNetworks ( );

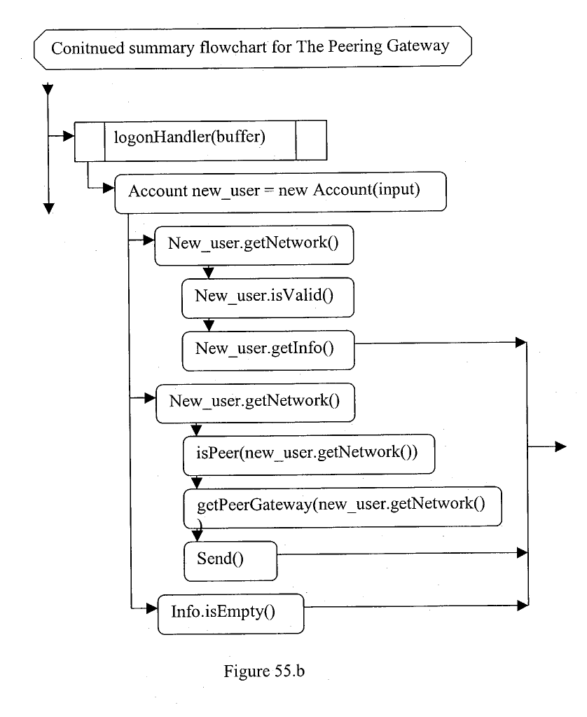

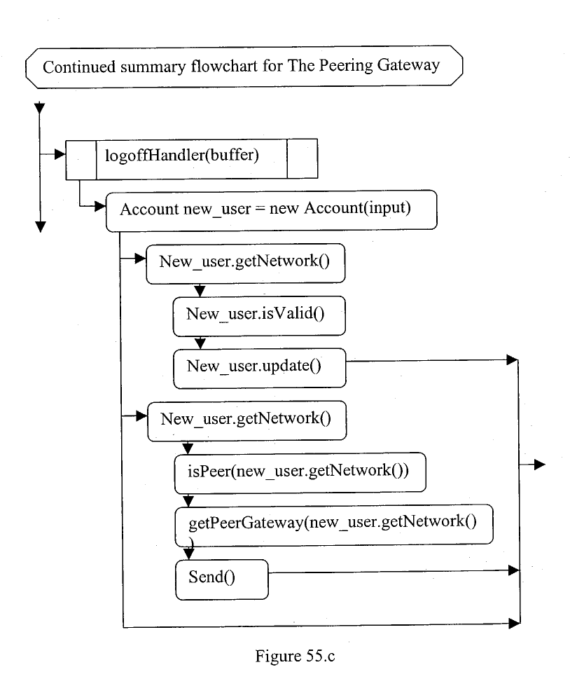

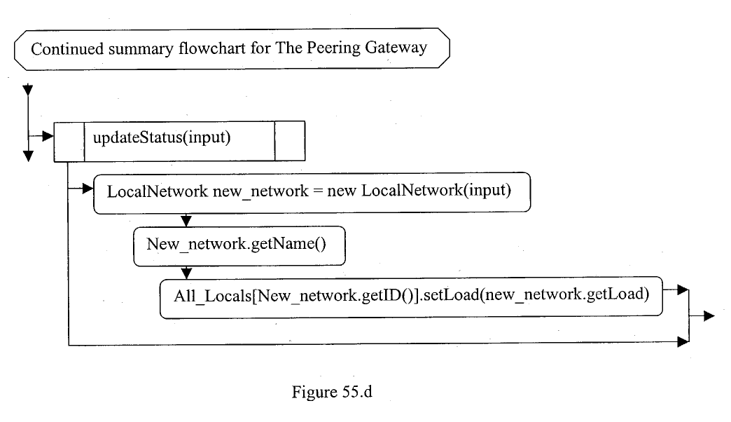

Flow Chart (FIG. 55)

Content Locator:

The Content Locator maintains the user transaction information and handles all requests. The machine running Peering Gateway must have three network interfaces, one for Internet connection, one for peer connection, and one for internal bypass network. The interfaces are named as follows:

1. Signaling interface: This interface has regular Internet connection. Content Locator communicates with Peering Gateway, other Content Locators, Edge Servers and Gateways through this interface in order to avoid congesting the Gigabit bypass network.

2. Bypass interface: This interface has Gigabit connection, and connects to all Content Locators on the bypass network and Peering Gateway. Content Locator accepts and sends requested content through this interface in order to provide fast file transfer rate.

3. Local interface: This interface has Gigabit connection as well, and connects to all Edge Server and Gateways on the local network. Content Locator accepts and sends requested content through this interface in order to provide fast file transfer rate.

All signaling are handled by signaling interface. The other two interfaces are reserved for data transaction only. The data structure and function of the Content Locator are described in details here.

Responsibilities

The Content Locator is the mediator of the entire system and is most complicated of all the units in this system. It has 7 primary responsibilities and 2 secondary hidden responsibilities. This module and its functions will be built using the UDP protocol and utilize broadcasting/multicasting techniques. All functions are built from scratch and code will eventually be encapsulated in OOP style.

The 7 Primary Responsibilities are:

1) Adding a process id and forwarding a logon request and user's information to the Peering Gateway for verification. This is implemented with: Send(logonHandler(buffer),peergateway)

2) Receiving a logon confirmation from a Peering Gateway, adding the user to the Content Locator's list and sending a response back to the client. This is implemented with: Send(logonConfirmer(buffer),getUserAddr(buffer))

3) Adding account info to the packet and forward it to the Peering Gateway indicating a log off request. This is implemented with: Send(logoffConfirmer(buffer), peergateway)

4) Receiving a logoff confirmation from a Peering Gateway, removing the user to the Content Locator's list and sending a response back to the client. This is implemented with: Send(logoffConfirmer(buffer),getUserAddr(buffer))

5) Handling content search requests from clients and other peered Content Locators. This is implemented with: RequestHandler(source, buffer)

6) Handling responses from Edge Servers and other peered Content Locators indicating the location of the requested media/content. This is implemented with: responseHandler( )

7) Handling web responses from web servers indicating if content is required from the web or not. This is implemented with: webresponseHandler( )

The Secondary hidden responsibilities work as follows:

1) On a regular basis, the Content Locator sends load information to its Peering Gateway.

2) On a regular basis, the Content Locator receives load information and status information from its local Edge Servers.

The Content Locator's main interactions are with the IntelliGateways, its local Edge Servers, their Peering Gateway and peered Content Locators. In accompany to the main code and functions, is a class called EdgeServer which is used to hold Edge Server status in a vector on the Content Locator. As well as a class called Requests which maintain a list of requests and responses to them. NOTE: The description of use of the first 4 primary functions is discussed in detail in the Peering Gateway Summary, on the Logon/Logoff procedures.

Data Structure

The following data structure, Class request {}, All_Accounts and Class Account {}, and Class Transaction {} are discussed elsewhere in this document.

Requestlist (FIG. 14): Please refer to the section on sequence figures (FIGS. 43-54) for a complete figure of Requestlist. However, all requests, which are currently handled by the Content Locator, are linked with its original requester's account.

All_Servers (Algorithm 10): This is a vector of EdgeServer. This vector is used to maintain the currently status of each edge server. This class is used to maintain the current status of each edge server. This will be held in a vector on the Content Locator.

Main Method

The main method (Algorithm 11) accepts incoming packets and calls the appropriate method based on the content of the packets. The main will be a never-ending loop constantly waiting for broadcast/multicast messages. The Content Locator will respond accordingly to every message that it receives.

Log On

The IntelliGateway will send logon info to the Content Locator, which then adds a process ID and forwards the information to the Peering Gateway.

The Content Locator will receive the following input from the Intelli-Gateway:

Task: log on;

ID: <userid>;

Network: <network name>;

Password: <########>;

Upon receiving and processing, the following output must be generated and sent to the Peering Gateway:

Task: log on;

UID: <Universal Process ID>;

ID: <userid>;

Network: <network name>;

Password: <########>;

Process (Algorithm 12):

Upon arrival of the log on information, the Content Locator assigned it a Universal Process ID (UID) and simply forwards the packet to Peering Gateway for validation.

The Peering Gateway will send an acknowledgement to the Content Locator if a user has successfully logged on or not, this message is then forwarded to the client via IntelliGateway.

The Content Locator will receive the following input from it's Peering Gateway:

Task: log on confirm;

UID: <Universal Process ID>;

Status: <status>;

ID: <userid>;

Network: <network name>;

Other account information: /* This field is left to provide more information for future development. */

Upon receiving and processing, the following output must be generated and sent to the Intelli-Gateway(which is then forwarded to the client):

Task: log on confirm;

Status: <status>;

Process (Algorithm 13):

Upon arrival of the log on confirmation, the Content Locator adds the new account to the list and informs the end user about the status.

Log Off

The IntelliGateway will send logoff info to the Content Locator, which then checks to see if they exist in their list of current active users, retrieves the information and forwards the information to the Peering Gateway.

The Content Locator will receive the following input from the Intelli-Gateway:

Task: log off;

ID: <userid>;

Network: <network name>;

Upon receiving and processing, the following output must be generated and sent to the Peering Gateway:

Task: log off;

ID: <userid>;

Network: <network name>;

Account information: <object of Account class>;

Process (Algorithm 14):

Upon arrival of the log on information, the Content Locator assigns it a Universal Process ID (UID) and pulls the account information from the list.

The Peering Gateway will send an acknowledgement to the Content Locator if a user has successfully logged off or not, this message is then forwarded to the client via Intelli-Gateway. At the same time, this client is removed from the Content Locator's list of active users.

The Content Locator will receive the following input from it's Peering Gateway:

Task: log on confirm;

UID: <#>@<local network name>@<bypass network name>;

Status: <status>;

ID: <userid>;

Network: <network name>;

Upon receiving and processing, the following output must be generated and sent to the Intelli-Gateway(which is then forwarded to the client):

Task: log on confirm;

Status: <status>;

Process (Algorithm 15):

Upon arrival of the log off information, the Content Locator simply deletes the account from the list and informs the log off status to the end user.

Handling Request

Either the Content Server configured as a client server or web server, the two levels of content search is same. Regardless of the searching method employed by Content Locator, this section list the general methods must be implemented.

There are two handlers. Each is invoked according to the current circumstances.

Case 1:

The Content Locator will contact its Edge Servers and request a search for the needed content. This broadcast occurs when a client first requests some media and when request from a peered Content Locator is looking for content.

The requestHandler will receive one of the following inputs passed in from main:

a) Task: “”;

UID: <#>@<local network name>@<bypass network name>;

Original request: <URL>;

Other information: /* This field is left to provide more information for future development. */

b) Task: multicast;

UID: <#>@<local network name>@<bypass network name>;

Original request: <URL>;

Other information: /* This field is left to provide more information for future development. */

Upon receiving and processing, the following output must be generated and sent to the Edge Servers:

Task: broadcast;

UID: <#>@<local network name>@<bypass network name>;

Original request: <URL>;

Other information: /* This field is left to provide more information for future development. */

Process (Algorithm 16)

Case 2:

This function is called by the response handler. This step is conducted after a response list has been generated consisting of the location of the requested content. What the function does is determine if a multicast is required if content is not found locally, or send messages to initiate content transfer. As well it sends a message to the web server telling it whether or not content is needed from the actual site.

The requestHandler2 will receive one of the following inputs from main:

a) Task: broadcast response;

UID: <#>@<local network name>@<bypass network name>;

Content Source: <edge server name>@<local network name>@<bypass network name>;

b) Task: multicast response;

UID: <#>@<local network name>@<bypass network name>;

Content Source: <edge server name>@<local network name>@<bypass network name>;

Upon receiving and processing, one of the following outputs must be generated and sent to the appropriate location:

a) Task: chosen source;

UID: <#>@<local network name>@<bypass network name>;

Original request: <URL>;

Other information: /* This field is left to provide more information for future development. */

b) Task: multicast;

UID: <#>@<local network name>@<bypass network name>;

Original request: <URL>;

Other information: /* This field is left to provide more information for future development. */

Process (Algorithm 17)

Send Request:

This function is a mini function called by requestHandler2. All it does is call a function called “webRequest(input,found)” to create an appropriate message and is sent out to web servers indicating if intervention by the web server is required.

The requestHandler2 will receive the following input:

None.

Upon receiving and processing, the following output must be generated and sent to the web server owning the requested content:

Task: web request;

UID: <#>@<local network name>@<bypass network name>;

Original request: <URL>;

Found: <found status>;

Other information: /* This field is left to provide more information for future development. */

Process (Algorithm 18)

Handling Web Response

This is the actual function that “moves” content from one location to another. Two possibilities can occur followed by a final data transfer that will always occur. If the content is found on a peered network, the data will be streamed over from the peered Edge Server to the local Edge Server, otherwise the content is not found it will make a request to the web server to stream the content to the local Edge Server. In either case data transfer will always occur after these if statements from the local Edge Server to the end User. (Note if the content is already found locally, neither of the if/else statement will apply and a direct transfer will occur as it always would with the other 2 cases).

The webresponseHandler will receive the following input:

None.

Upon receiving and processing, one of the following outputs must be generated and sent to the appropriate location:

a) Task: ACK;

UID: <#>@<local network name>@<bypass network name>;

Original request: <URL>;

Target: <edge server name>@<local network name>@<bypass network name>:<port>;

b) Task: ACK;

UID: <#>@<local network name>@<bypass network name>;

Original request: <URL>;

Source: <edge server name>@<local network name>@<bypass network name>:<port>;

Process (Algorithm 19):

When the web response arrives at this Content Locator, it informs the appropriate source and the gateway to start the data transmission. The target edge server is the least busy local edge server chosen by Content Locator.

Handling Broadcast/Multicast Responses

This function is always called by main, after all content requests have been responded to. This is called after receiving the # of broadcast responses equal that of Edge Servers, or # of multicast responses equal that of the number of Content Locators.

The responseHandler will receive the following input:

None.

Upon receiving and processing, the following output may be generated and sent to the original Content Locator:

Task: multicast response;

UID: <#>@<local network name>@<bypass network name>;

Content Source: <edge server name>@<local network name>@<bypass network name>;

Process (Algorithm 20):

For broadcast responses, Content Locator does not need to choose edge server since there could be only one Edge Server has the requested content. For multicast responses, Content Locator would choose the best edge server to use base on predefined priorities of peered networks and current network load. The chosen source edge server would be informed so it would make sure the content would be there at the time of transfer. chooser:

This picks the best server from the list to use as the source. The method for load checking is to be further researched.

The responseHandler will receive the following input:

None.

Upon receiving and processing, the following output may be generated:

None.

Process (Algorithm 21)

Computing Load

This server computes the percentage of network load on a regular basis and sends it peered networks The algorithm is still unknown. This will most likely be a thread with a sleep timer on it. All the function does is conduct some computation of load percentage (algorithm not yet chosen) and send the report to the Content Locator's Peering Gateway.

The Content Locator will receive the following input:

None.

Upon receiving and processing, the following output must be generated and sent to the Content Locator's Peering Gateway:

Task: status;

Network: <local network name>;

ID: <ID assigned by Peering Gateway>;

Load: <load percentage>;

No process (Algorithm code) at the moment. (Improvise)

Local Network Information

On a regular basis, the new status of each peered network and Edge Server is sent to Content Locator. The new status would be updated accordingly. This is another thread running in the background. It will most likely be a never ending loop waiting for input from its Edge Servers. It will keep a list of Edge Servers and their status and update any status changes among them.

The Content Locator will receive the following input from its Edge Servers:

Task: status;

Network: <local network name>;

ID: <ID assigned by Peering Gateway>;

Load: <load percentage>;

Upon receiving and processing, the following output must be generated:

None.

Process (Algorithm 22):

The new status would be updated accordingly.

Transaction History

The Content Locator maintains a transaction history for each currently active account. It records all necessary information into the database. Each Edge Server reports the transaction status to the Content Locator while the transaction is happening.

Before the Edge Server streaming the file to the client, it informs the Content Locator amount of data would be streamed. If a failure occurs, the Content Locator receives a notice ASAP. When an alternative Edge Server was chosen to continue the streaming, this Edge Server informs the Content Locator as well. Upon transactions successful, the record would be updated. A user might have more than one transactions, each transaction would be recorded as a separate record.

When the user logs off on this network, these records would be sent to the Peering Gateway for future billing. If the log off failure occurs, the record stays on this server. However, Content Locator synchronize the account information with appropriate Peering Gateway as scheduled by network administrator in order keep the database consistence.

Other Global Methods:

The Algorithms for the following methods are presented since they are very trivial and straightforward to implement.

/* This verifies if the given network name is a member of peering networks. */ Boolean isPeer(String <network name>);

/* This verifies if the given IP address is the Peering Gateway for one of the peering networks. */

Boolean isPeer(String <IP address>);

/* This verifies if the given network name is a member of neighbor networks. */

Boolean isLocal(String <network name>);

/* This gets the priority base on the given bypass network name. */

int getPriority(String <network name>);

/* This gets the priority base on the IP address of the given Peering Gateway. */

int getPriority(sockaddr_in <IP address>);

/* This verifies if the given IP address is the neighbor content locator. */

Boolean isLocal(String <IP address>);

/* This parses out the Task field in the packet. */

String getTask(String buffer);

/* This parses out the userid field of the packet. */

String getUserID(String buffer);

/* This parses out the source field of the packet. */

String getSource(String buffer);

/* This parses out the UID field of the packet. */

String getUID(String buffer);

/* This parses out the status field of the packet. */

String getStatus(String buffer);

/* This sends the given data to the target. */

Boolean send (String data, sockaddr_in target);

/* This method generates a new universal process ID. */

int getNewUID( );

/* This method generates a new universal process ID. */

void deleteUID( );

/* This method generates a request to the Peering Gateway. */

int peeringRequest( );

/* This method generates a basic request. */

int createRequest( );

/* This method generates a web request. */

int webRequest( );

/* This method broadcasts the data in buffer to local network. */

int peerMulticast(buffer);

/* This method broadcasts the data in buffer to all the neighbor local networks. */

int neigborBroadcast(buffer);

/* This method chooses the least busy edge server at the moment. */

String getEdgeServer ( );

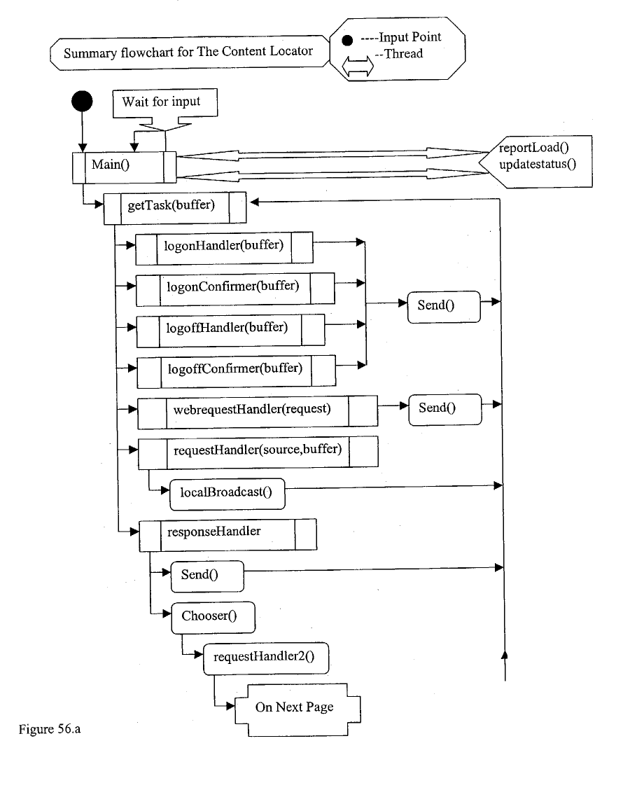

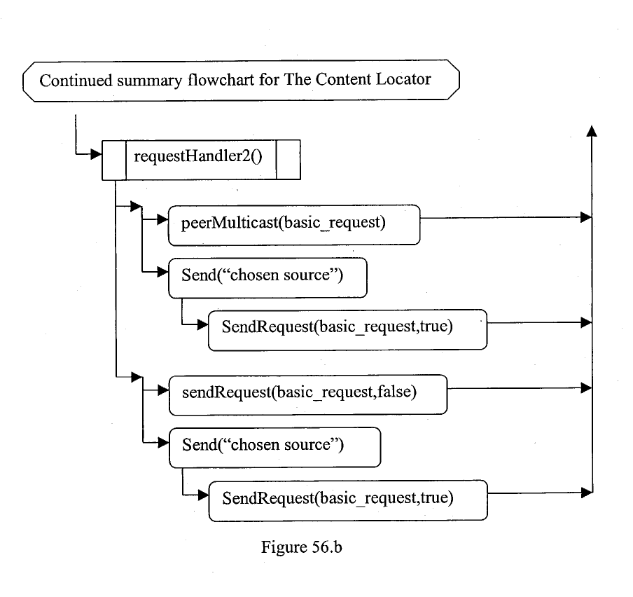

Flow Chart (FIG. 56)

Edge Server:

The Edge Server caches the content and streams the content to the end users. The machine running Edge Server must have two network interfaces, one for Internet connection, and one for peer connection. The interfaces are names as follows:

1. Signaling interface: This interface has regular Internet connection. The Edge Server communicates with the Content Locator and Gateways through this interface in order to avoid congesting the Gigabit bypass network. Data might be arrived from the actual web server on this interface. This interface is also used to stream the content to end user.

2. Local interface: This interface has Gigabit connection as well, and connects to the Content Locator of the local network. Edge Server sends requested content through this interface in order to provide fast file transfer rate.

All signaling are handled by signaling interface. The interface is reserved for data transaction only. The data structure and function of the Edge Server is described in detail in this section.

Responsibilities

The Edge Servers contain the final content and has 4 primary responsibilities and a secondary hidden responsibility. They will be build using the UDP protocol and utilize broadcasting/multicasting techniques. All functions are built from scratch. The code will eventually be encapsulated in OOP style.

The 4 Primary Responsibilities are:

1) Searching the Cache for requested contend and report back if found or not. This is implemented with: String broadcastHandler(String input)

2) Acknowledging, preparing and sending via Gigabit connection (Local Interface) to the target location given. This is implemented with: Void ackHandler(input)

3) Receiving notification that this particular Edge Server will act as the source for some content to be delivered. The edge server must inform the Cache of this, such that the cache will make sure the content is made available for a period of time. This is implemented with: String noteHandler(String input)

4) When the Edge Server requests by the gateway, the Edge Server must prepare data and stream it to the end user via Internet connection (Signaling interface). This is implemented with: Void requestHandler(requester, input)

The Secondary hidden responsibility works as follows:

The function will run as a C++ variation of the pthread library which is used in C. This variation however may not be compatible with all compilers/OS's. Therefore, the main code may still run but the thread may not. What this thread will do is periodically compute and report its load percentage on a regular time interval basis. This is implemented with: Void reportLoad( );

As described above, the Edge Servers only directly interact with it's Content Locator and it's Intelli-Gateway.

Main Method

The main method (Algorithm 23) accepting incoming packets and calling the appropriate method base on the content of the packets. This will be a never-ending loop constantly waiting for broadcast messages. The Edge Server will respond accordingly to every message that it receives.

Handling Broadcast

When the Content Locator is looking for a requested media/content, the following method is called. The method looks for the content in the cache and replies to the broadcast the result of the search

The Edge Server will receive the following from the Content Locator:

Task: broadcast;

UID: <#>@<local network name>@<bypass network name>;

Original request: <URL>;

Other information: /* This field is left to provide more information for future development. */

Upon receiving and processing, the following output must be generated and sent back to the Content Locator:

Task: broadcast response

UID: <#>@<local network name>@<bypass network name>

Source: <edge server name>@<local network name>@<bypass network name>

Process (Algorithm 24):

When the broadcast message arrives, the Edge Server translate the broadcast message into a language can be understand by the cache server. When the cache server responses to the query, the Edge Server translates the response to a broadcast response message.

Handling Acknowledgement

At this point, the notification method has already been called and content is waiting to be delivered. Once the Content Locator has chosen a target Edge Server to transfer data to, this function is called to initiate the transfer. NOTE: This is when this Edge Server is acting as the source of the content. The Edge Server will prepare the data and start to send the data to the target address via Gigabit connection(Local interface).

The Edge Server will receive the following from the Content Locator:

Task: ACK

UID: <#>@<local network name>@<bypass network name>

Original request: <URL>

Target: <edge server name>@<local network name>

@<bypass networkname>:<port>

Upon receiving and processing, the following output must be generated

None

Process (Algorithm 25):

The Edge Server would prepare the data and start to send the data to the target address. On the bypass interface, a special routing table is to provide route to the destination base on server name and network names.

Handling Notification

If the content is on this Edge Server, which is not on the local network of the client, but rather on the bypass network, the Content Locator will send a notification to this Edge Server that this server is the designated source server. When a notification arrives, the Edge Server translates it to a cache readable message. From there the Edge Server would make sure the content would be available for a period of time.

The Edge Server will receive the following from the Content Locator:

Task: chosen source

UID: <#>©<local network name>@<bypass network name>

Original request: <URL>

Other information: /* This field is left to provide more information for future development. */

Upon receiving and processing, the following output must be generated

None

Process (Algorithm 26):

When the notification message arrives, the Edge Server translate the message into a language can be understand by the cache server. The cache would make sure the content would be available for a period of time.

Handling Request and Broadcast

This function is used to send content to the Intelli-Gateway which is then forwarded to the client. (The final steps in content delivery)

The Edge Server will receive the following from the Intelli-Gateway:

Task: request;

UID: <#>@<local network name>@<bypass network name>;

Original request: <URL>;

Other information: /* This field is left to provide more information for future development. */

Upon receiving and processing, the following output must be generated

None.

The Peering Gateway would wait for response from the peered networks. Next sub-section describes how the Peering Gateway would handle the broadcast responses.

Process (Algorithm 27):

The request is send by the gateway. The Edge Server get the data ready and start streaming to the end user.

Computing Load

This server computes the percentage of load on a regular basis and sends it to the Content Locator. This factor can be used to determine the least busy Edge Server on the network. In other words, it helps the Content Locator load balancing the Edge Servers.

The Edge Server will receive the following:

None

Upon receiving and processing, the following output must be generated

Task: status;

Network: <local network name>;

ID: <ID assigned by Peering Gateway>;

Load: <load percentage>;

Process (Algorithm 28):

Each edge server performs the following task to report the current load.

Other Global Methods:

The Algorithm codes for the following methods are presented since they are very trivial and straightforward to implement.

/* This method translates the input to a cache query. */

String getCacheQuery(String input);

/* This method queries the cache. */

String locateContent(String query);

/* This method translates the cache query result into broadcast response. */

String getResult(String result);

/* This method translates the input into data query in order to pull the data from secondary storage. */

String getDataRequest(String input);

/* This method pulls the data from secondary storage and send to the target. */

void dataTransfer(String datarequest);

/* This method translates the input into cache update request. */

String getCacheUpdate(String input);

/* This method updates the content in the cache. */

void updateCache(String update);

/* This method translates the input into streaming request, which could be understood by the Streaming Server. */

String getStreamRequest(sockaddr_in requester, String input);

/* This method starts to stream the data to the end user. */

void streaming(streamrequest);

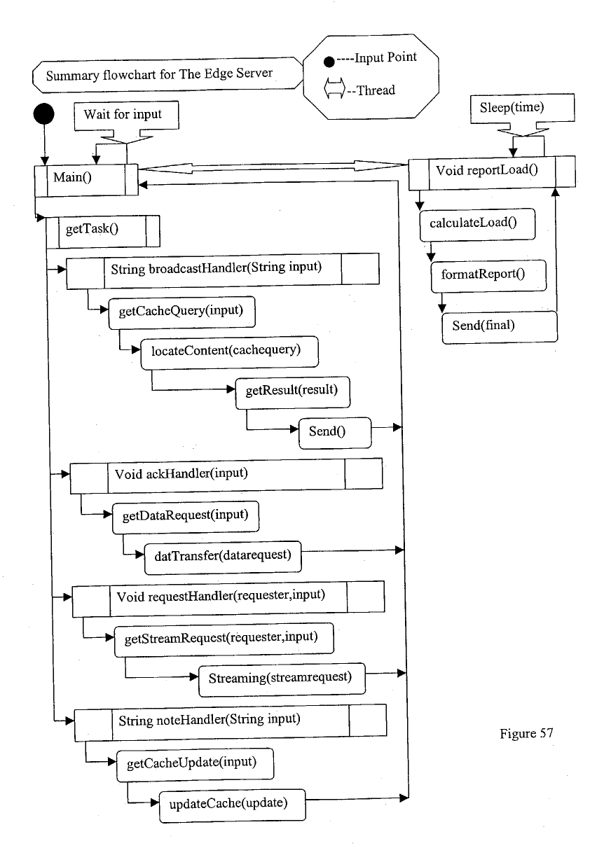

Flow Chart (FIG. 57)

IntelliGateway:

The IntelliGateway forwards the original request and contact the source edge server to start streaming media. The machine running IntelliGateway must have two network interfaces, one for Internet connection, and one for client connection. The interfaces are names as follows:

1. Signaling interface: This interface has regular Internet connection. The IntelliGateway communicates with the Content Locator and Edge Servers through this interface.

2. Client interface: This interface has regular Internet connection. The IntelliGateway communicates with the Client through this interface.. The data structure and function of the IntelliGateway is described in detail in this section.

Responsibilities

The IntelliGateway is the main link between the client and the rest of the system. It has 2 primary responsibilities and a secondary hidden responsibility. This module and it's functions will be built using the UDP protocol and utilize broadcasting/multicasting techniques. All functions are built from scratch and code will eventually be encapsulated in OOP style.

The 2 Primary Responsibilities are:

1) Forwarding client requests to the Content Locator This is implemented with: Send(buffer, contentlocator)

2) Receives an acknowledgement from the Content Locator that a nearby Edge Server is ready with the requested content This is implemented with: Void ackHandler(buffer)

The Secondary hidden responsibility works as follows:

Once an Edge Server starts streaming data to an IntelliGateway, that IntelliGateway must be able to forward the streaming content to the end user (the initial client who requested the data). NOTE: For the time being, this function will probably not need to be coded on an application level.

The Intelli-Gateways main interactions are with the Client, the Edge Servers and the Content Locator.

Main Method

The main method (Algorithm 29) accepting incoming packets and calling the appropriate method base on the content of the packets. The main will be a never-ending loop constantly waiting for broadcast messages. The IntelliGatway will respond accordingly to every message that it receives.

Handling Request Response

The IntelliGateway will contact the given Edge Server and request data to be transferred and then forwarded to the client requesting the content.

The IntelliGateway will receive the following input from the Content Locator:

Task: ACK

UID: <#>@<local network name>@<bypass network name>

Original request: <URL>

Target: <edge server name>@<local network name>

@<bypass network name>:<port>

Upon receiving and processing, the following output must be generated and sent to the Edge Server.

Task: request

UID: <#>@<local network name>@<bypass network name>

Original request: <URL>

Other information: /* This field is left to provide more information for future development. */

Process (Algorithm 30):

The IntelliGateway would send the request to the target edge server, which should contain the requested content.

Other Global Methods

The Algorithm codes for the following methods are presented since they are very trivial and straightforward to implement.

* This method creates a request base on the acknowledgement message. */

String createRequest(input)

/* This method parses out the target field in the input. The target edge server would contain the source of the content. */

String getSource(input);

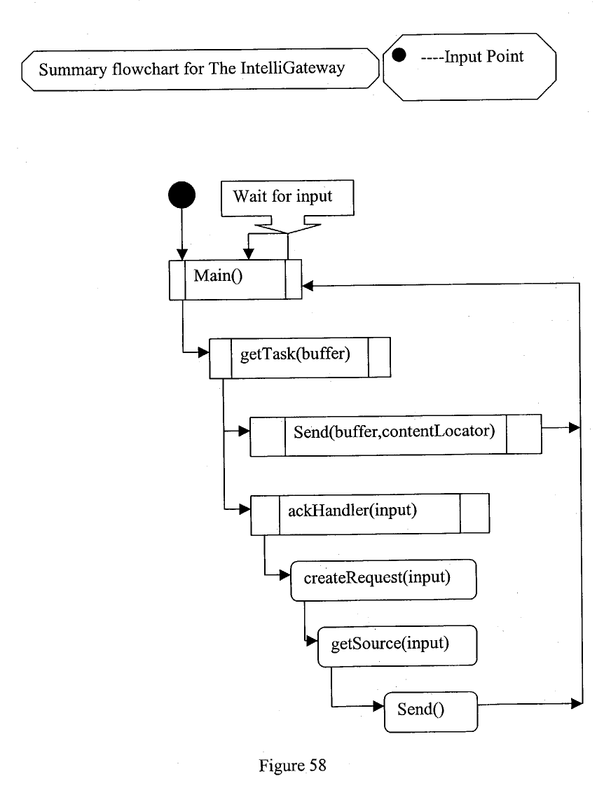

Flow Chart (FIG. 58)

SmartClient:

The SmartClient forwards the original request and contact the source edge server to start streaming media. The machine running SmartClient must have one network interface for Internet connection. The interface is named as follows:

1. Network interface: This interface has regular Internet connection. The SmartClient communicates with the Content Locator and Edge Servers through this interface. The data structures and functions of the SmartClient are described in details here.

Responsibilities

The Smart Client is an added feature to this project. It's different than a normal client in that it detects and self configures upon connecting to the network. As such, the Smart Client takes on the role of an IntelliGateway and a regular client. It has 3 primary responsibilities and a secondary hidden responsibility. This module and its functions will be built using the UDP protocol and utilize broadcasting/multicasting techniques. All functions are built from scratch and code will eventually be encapsulated in OOP style.

The 4 Primary Responsibilities are:

1) Requesting content. The request is forwarded to the Content Locator. This is implemented with: Send(buffer,contentlocator)

2) Receiving acknowledgements from the web. This is implemented with: ackHandler(buffer)

3) Receiving and reacting to a response to a probe that the Smart Client has sent out. This is implemented with: Selfconf(buffer)

The Secondary hidden responsibilities work as follows:

When initially connecting to the network, the Smart Client must send out a probe to find the Content Locator on the network that it is attempting to connect to. If a Content Locator exists, the Smart Client will receive a response.

The Smart Client's main interactions are with the Edge Servers and its Content Locator. The Smart Clients act very much in the same manor as the IntelliGateways do. Use case descriptions can be found in the Content Locator document. A simple way of understanding the smart client is that it acts as an IntelliGateway AND as an end user.

Main Method

The main method (Algorithm 31) accepting incoming packets and calling the appropriate method base on the content of the packets. The main will be a never-ending loop constantly waiting for broadcast/multicast messages. The Smart Client will respond accordingly to every message that it receives.

Handling Request Response

The ackHandler will handle an acknowledgement response that content is available and sends a request to the Edge Server containing that content.

The Smart Client will receive the following input from the Content Locator:

Task: web ACK;

UID: <#>@<local network name>@<bypass network name>;

Original request: <URL>;

Target: <edge server name>@<local network name>@<bypass network name>:<port>;

Upon receiving and processing, the following output must be generated and sent to the Edge Server:

Task: request

UID: <#>@<local network name>@<bypass network name>

Original request: <URL>

Other information: /* This field is left to provide more information for future development. */

Process (Algorithm 32):

The SmartClient would send the request to the target edge server, which should contain the requested content.

Probing for Content Locator

SmartClient probes for Content Locator on the network by first sending out probing request. If Content Locator exists on the network, it would reply to this quest.

Upon connecting to the network, the Smart Client must send out a search to “probe” for a Content Locator, which in turn also indicates that this network is running our system. There for before the infinite loop is initiated, there must be a function prior to the loop such that the probe is sent, verified by the Content Locator and send a response back. This response is then captured in the Smart Client's while loop

The Smart Client will receive the following input

None.

Upon receiving and processing, the following output must be generated and sent to the Content Locator:

Task: probe;

network information: <network information the machine currently collected>;

Process (Algorithm 33)

Self Configuration

The Smart Client will configure itself in order to communicate properly to the network if it has received a probe response from a Content Locator (indicating that this server provider is running our system).

The Smart Client will receive the following input from it's Peering Gateway:

Task: probe response;

Address: <bypass network address of Content Location>;

IP address: <IP address of Content Locator>;

Others: /* to be added */

Other Global Methods:

The algorithms for the following methods are presented since they are very trivial and straightforward to implement.

/* This method creates a request base on the acknowledgement message. */

String createRequest(input)

/* This method parses out the target field in the input. The target edge server would contain the source of the content. */

String getSource(input);

/* This method self configure as a client of Content Locator. */

String selfconf(input);

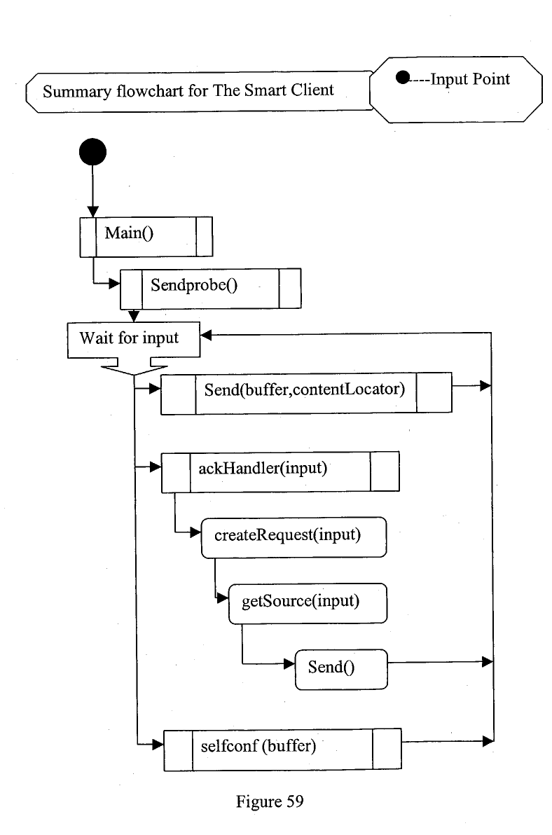

Flow Chart (FIG. 59)

### DESCRIPTION OF A PREFERED EMBODDIMENT

The CDN bypass network uses Session Initiation Protocol (SIP), to set up connections between components. SIP is usually used for Voice over IP (VoIP) calls. According to RFC 2543, the Session Initiation Protocol (SIP) is an application-layer control protocol that can establish, modify and terminate multimedia sessions or calls. SIP provides mechanisms for determining user location, capabilities, and availability, as well as call setup and call handling.

There are six types of methods in SIP requests. They are INVITE, ACK, OPTIONS, BYE, CANCEL, and REGISTER. According to SIP RFC, the definition of each method is as follows. The INVITE method indicates that the user or service is being invited to participate in a session. The ACK request confirms that the client has received a final response to an INVITE request. A server that believes it can contact the user, such as a user agent where the user is logged in and has been recently active, may response to the OPTION request with a capability set. This method also allow the server is being queried as to its capabilities. The user agent client uses BYE to indicate to the server that it wishes to release the call. The CANCEL request cancels an appropriate pending request. A user agent may register with a local server on startup by sending a REGISTER request to the well-known “all SIP servers” multicast address “sip.mcast.net” (224.0.1.75).

The SIP is best fit for the project in the following ways:

The biggest feature of this project can be accomplished by the REGISTER method. When the user and his/her laptop move from site to site, the machine can be dynamically registered with the nearby local SIP server, as well as assign a log on duration time.

To ensure load balance servers on the network, the local server can use other mechanisms, such as ping, trace route, or finger to determine the capacity of each Edge Server and neighbor local server. The information can be sent via the OPTION method.

To reduce and avoid network congestion, a request may contain a Record-Route request and response header field to ensure the packets are travel in certain path. Each server on the network adds its address to the Via field as the packets pass by. The Via field ensures the replies are traveled in the same path back to the requester. This gives the system total control of network traffic and how the packets are transmitted.

To protect the network from intruder, the Hide request header field can be included in the request in order to hide the Via header fields from the subsequent servers. The Max-Forwards request-header field may be used to limit the number of proxies or gateways in the path to avoid malicious action on the network.

There are two types of proxy, stateful and stateless. According to SIP RFC, A stateful proxy remembers the incoming request, which generated outgoing requests, and the outgoing requests. A stateless proxy forgets all information once an outgoing request is generated. (Have not decided type of proxy to use yet.)

For billing purpose, the proxy-Authorization field is employed to maintain credentials containing the authentication information of the user agent for the proxy and/or realm of the resource being requsted.

SIP Integrated With CDN (Registering)

How it works:

When the user clicks on connect from a smart client, a probe must be sent to see if a Content Locator exists on the network that he just connected to.

This is done with a SIP Register message that is sent to the network SIP server. The request includes the user's contact list. IE: where (s)he can be contacted.

The SIP server responds by asking for the User's id and password.

The User's SIP client will encrypt the user information and send the response to the SIP server. The SIP server will validate this user by forwarding just logon information up to the peering gateway.

The logon procedures in document Peering Gateway take place.

Once the user is confirmed, the SIP server registers the user in its contact database and returns a response (200 OK) to the user.

It is assumed that the user has not previously registered with this user. But upon disconnection, the user information will be cleared from the SIP server's database.

Unsuccessful:

If the user is not confirmed, then an unauthorized message is passed back to the client.

The client then picks up the message, decodes it and will display an incorrect user/password error.

Note: Proper message format and information in the message is indicated in RFC 2543.

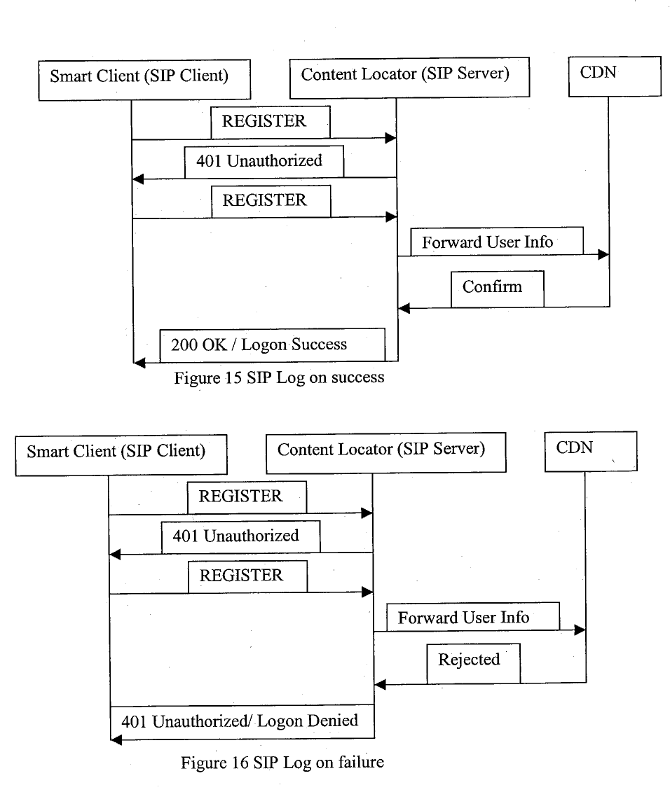

Use case for logon success (FIG. 15)

Use case for logon failure (FIG. 16)

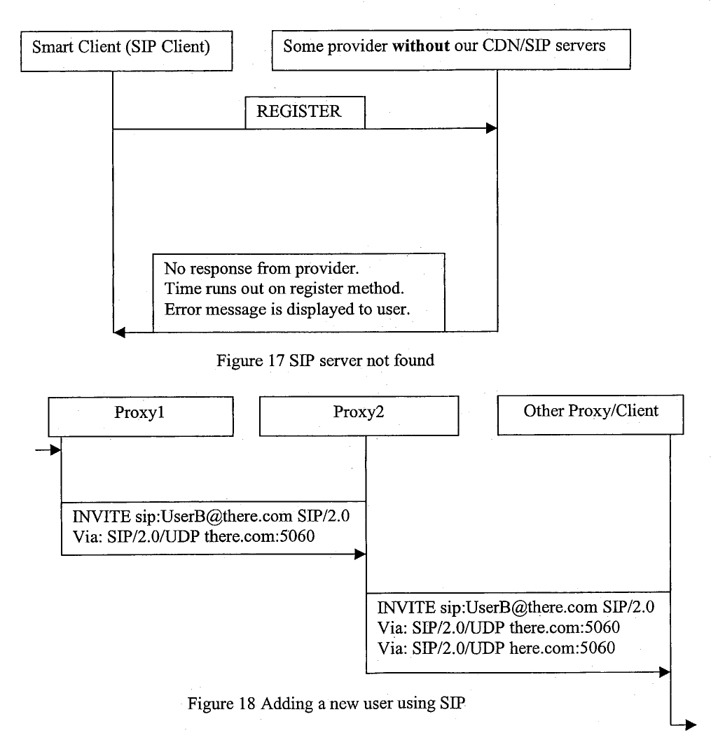

Use case for SIP server not found (FIG. 17)

Smart Client:

Algorithm 34 is called when the user has made a connection (well technically at the same time). This is because if there doesn't exist a SIP server, then the code will time out and return an error to the user.

Content Locator:

UDP setup (Algorithm 35), receive and send are the same procedures as in Smart Client. There for this code just calls the function assuming they've been built into the code already. IE: start_udpSender( ); and udpSend( );

Extra functions:

These functions still need to be created. Most of which are very trivial, while others have a little more description to them.

current_time( ):This refers to the current time. It does not necessarily have to be in hh:mm:ss format, it is actually preferred to be all in seconds in order to have more precise control over time out sessions and easier to calculate the differences.

encrypt( ): This is some sort of encryption algorithm that's chosen by the programmer.

make_reg2_msg( ): This function will take the user's info, encrypt it with encrypt( ), add it to the SIP message and a new SIP Register message is made. Exactly where the encrypted information lies is still to be researched. The CSEQ will be set to 2 in this case. An “Authorization:” line is needed to be added to the SIP structure which still needs to be discovered with OSIP as well.

display_connect_status( ): This is equivalent to popping up a GUI informing that the user has made a successful connection.

display_error( ): This function brings up a GUI on the user's end informing them of a particular error that had occurred.

make_unauth_msg( ): This will create the response message as well as add the “Authenticate:” header to the sip structure. It is similar to the make_ok_msg( ), except further research is required to properly add the “Authenticate” line to the SIP structure using OSIP.

SIP Integrated With CDN (Message Transportation)

The Smart Clients, IntelliGateways, Peering Gateways, and Content Locators: Every time a message passes through a system on the CDN, the address of whatever it passed through is implanted in the SIP message in the VIA field. What we want to do with the VIA field is to Hide it from possible malicious action. Furthermore we want to add a Max-Forwards field to the message for the same reasons. Additionally to the message we want to put in a Record-Route field, which can be manipulated as pleased, in order to have full control over network traffic. We assume that the Algorithm 36 will exist in each of the machines that is required to take in messages.

Adding addy's to VIA (FIG. 18):

Every time a message passes through some machine, its address is added to another VIA field, tacking on top of existing VIAs.

Therefore a message may look like the following:

INVITE sip:UserB@there.com SIP/2.0

Via: SIP/2.0/UDP there.com:5060

Via: SIP/2.0/UDP here.com:5060

Rest of the body for the message.

As you can see the message must pass through 2 servers before reaching its destination, UserB. Please see Algorithm 36 for detail description.

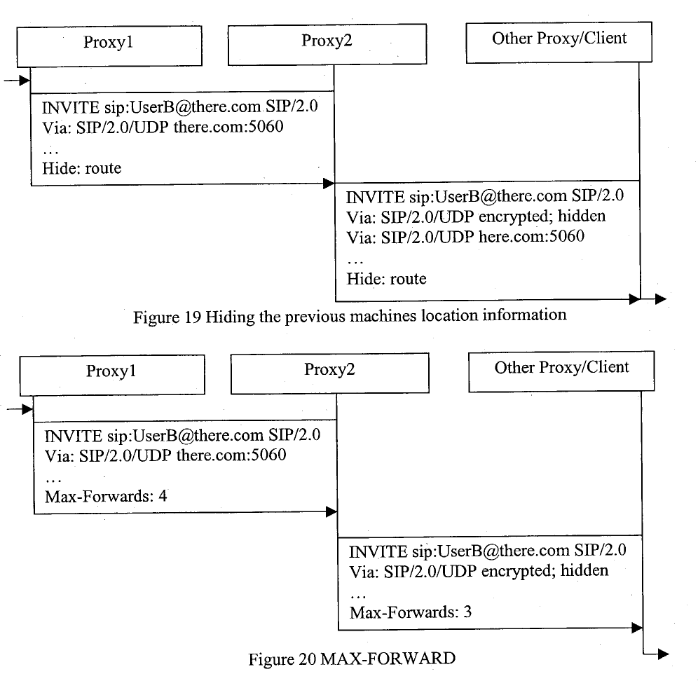

Hide (FIG. 19):

When ever a proxy or server receives a SIP message, it will hide the previous machines location information. IE: Address, Port etc. There are two modes for hiding, route and hop. We are only concerned with route because it eventually hides all of the IPs, excluding the final destination address. Therefore a message may look like the following:

INVITE sip:user@company.com SIP/2.0

To: sip:user@company.com

From: sip:caller@university.edu

Call-ID: 9@10.0.0.1

CSeq: 1 INVITE

Via: SIP/2.0/UDP 135.180.130.133

Hide: route 0

Content-Type: application/sdp

Content-Length: 174

v=0

o=mhandley 29739 7272939 IN IP4 126.5.4.3

s=SIP Call

c=IN IP4 135.180.130.88

t=3149328700 0

m=audio 49210 RTP/AVP 0 12

m=video 3227 RTP/AVP 31

a=rtpmap:31 LPC/8000

Each machine is responsible for hiding the previous machines contact information. Which means that in order to produce a proper message, functions must be coded by hand to do so.

An algorithm is not yet available for this option is not implemented into OSIP yet. Development for this header is needed with reusing the API proposed in the oSIP manual under the section of “SIP headers”.

Max-Forwards (FIG. 20):

Max-Forwards Algorithm to limit the number of proxies and gateways the message passes through. This helps in preventing malicious action against clients.

The SIP message may look like the following:

INVITE sip:user@company.com SIP/2.0

To: sip:user@company.com

From: sip:caller@university.edu

Call-ID: 9@10.0.0.1

CSeq: 1 INVITE

Via: SIP/2.0/UDP 135.180.130.133

Max-Forwards: 0

Content-Type: application/sdp

Content-Length: 174

v=0

o=mhandley 29739 7272939 IN IP4 126.5.4.3

s=SIP Call

c=IN IP4 135.180.130.88

t=3149328700 0

m=audio 49210 RTP/AVP 0 12

m=video 3227 RTP/AVP 31

a=rtpmap:31 LPC/8000

The UA initially sets the Max-Forwards, say 6, and each machine it passes through is responsible for reducing that number and updating the message before passing it on. Please see Algorithm 37 for detail description.

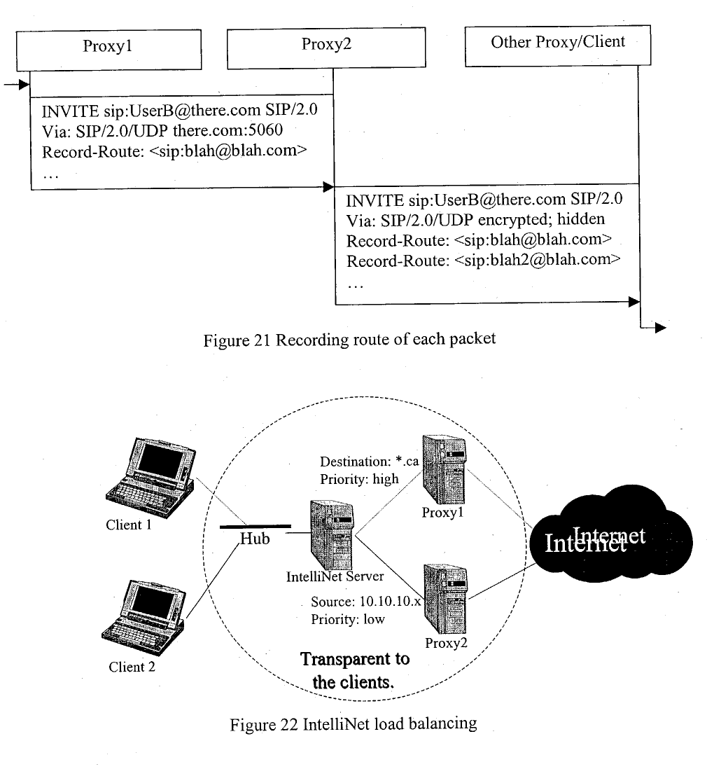

Record-Route (FIG. 21):

This works by proxies volunteering to add their location information to this list. Key word is voluntary. The programmer and designer decide which proxies opt to add in their information. Information is always added to the front of the list. Unlike the VIA field where more headers are added, Record-Route just maintains one large list. The SIP message may look like the following:

INVITE sip:jack@atosc.org SIP/2.0

Via: SIP/2.0/UDP Ed.TestCom:5060

Record-Route: <sip:route_name_@blah.com>

Record-Route: <sip:route_name_{—}2@baah.com>

Rest of the sip messag.

The code is exactly that of the via program stated above. The only difference is the optional addition of the line:

msg_setrecord_route(sip,strdup(“sip:route_name_{—}1@blah.com”));

Note:

1. When receiving the message, the User Agents are responsible for reversing the order of the addresses to make sense of the route.

2. Proper message format and information in the message is indicated in RFC 2543.

### INTELLINET

Introduction:

Internet has become a real business tool. Everyone wants low-cost, fast and reliable internet access anywhere and anytime. Service providers are interested in new and enhanced high quality network services. There is also potential for new business opportunities and applications for corporate users.

The standard network usually requires the client computers to be properly configured to meet its architecture. For example, the user needs to enter IP address of proxy server, IP address of gateway and DNS server on this network. Nonetheless, not every user knows how to configure TCP/IP settings. The IntelliNet system provides configuration-free internet access. On top of that, the system balances the load of each proxy server by redirecting requests to appropriate server base on destination, source or service type of the request. The network administrator can setup the IntelliNet system to handle requests with priorities. This system can also handle both proxy requests and non-proxy requests. It basically translates all non-proxy requests to proxy requests, then forward the requests to the appropriate proxy server. The system can not only handle regular internet requests, but also streaming media. It also can control the size of data being transferred to improve performance of network, and optimize the TCP signaling to avoid congestion. Other new features of IntelliNet system includes automatically learn new application on the network and self trained in order to handle the new application. The last but not the least, it can centralize cookies to reduce network traffic.

List of Contribution:

IntelliNet provides configuration free access to the Internet. A client with any arbitrary configuration or setup can connect to the network that has IntelliNet server running. The arpspoof program accepts all ARP requests coming through the client-side network and responds with its client-side MAC address. The client would think IntelliNet server is the server it's originally looking for.

Whenever a request initiated by one of the client, IntelliNet has total control of the packets. It rewrites the packets as necessary so the packets look like initiate by IntelliNet server, then sends the request to its destination or proxy server. Whenever a response comes back from Internet or proxy server, IntelliNet locates the client who send the original request. It rewrites the packets as necessary to the packets look like the response the client was expecting, then passes the packet to the client.

IntelliNet can handle both proxy requests and non-proxy requests. When it receives proxy requests, then passes them to the appropriate proxy server without any modification. When it receives non-proxy requests, it extras the information from the packet, writes the proxy request, then sends the proxy request off to the appropriate proxy server.

A new method is implemented to handle the requests with priorities. When IntelliNet receives a request, it looks up the priority rules table first. If a rule matches the arguments in the request, the proxy server to that level of priority would be used to handle this request. If no rule matches the arguments in the request, the proxy server for the default priority would be used. The rules are specified in the listen.conf file. The system administrator assigns a proxy server for each level of security, and specifies priority rules. The administrator can also mix and match the rules by specifying any fields of target, source and service type.

The IntelliNet system can convert connection type. It receives a packet in any format and rewrites the packet in a different format.

The IntelliNet system can automatically learn new application on the network and self trained in order to handle the new application. If there is a new network application existing on the network, the program would watch the traffic and try to handle the packet. Eventually it can understand the pattern and add a new handler to handle this new application.

The IntelliNet stores the cookies on a centralized database machine. If a user moves from one machine to another machine, there's no need to create new cookies for the same web page he/she visited. Whenever the web server requests for cookie from a client, the IntelliNet server goes to this cookie database server and fetch the information about this client. This obviously reduces lots of network traffic.

The IntelliNet has a listener port on each side of the network to accept all types of network requests on any port. The ipchains program forwards requests on all ports to a port, which is used as the listener port.

The IntelliNet provide mechanism to handle streaming media. When the client machine with arbitrary setting initiate a SIP connection. The IntelliNet system pretends to be the client machine and make the connection with the machine on the outside of the network. When the machine on the outside replies to the IntelliNet server, it rewrite the packet so the destination of the packet is the client and forward.

IntelliNet new features

Load Balancing: (FIG. 22) On large size network, usually the proxy servers are overloaded with all kinds of requests. It would be nice if different request can be redirect to different proxy servers. For example, for the requests for government information web pages can be redirect to faster proxy server since mostly people looking at these web pages for work related purpose. On the other hand, the requests for MP3 web pages can be redirect to a slower proxy server. On a network like this, it saves lot of resources.

IntelliNet is implemented with priority rules. The rules are specified in listen.conf file. The system administrator assigns a proxy server for each level of security, and specifies priority rules. The administrator can also mix and match the rules by specifying any fields of target, source and service type. When IntelliNet receives a request, it look up the priority rules first to set the priority level of this request, then it look up the proxy server table for the corresponding proxy server to use. The following is a sample listen.conf file.

clientSide_IP 192.168.6.1

proxySide_IP 198,163.152.136

default_priority 2

proxy http 1 198.163.152.136 8080

proxy http 2 198.163.152.119 80

proxy ftp 1 198.163.152.119 80

proxy ftp 2 198.163.152.119 80

proxy dns 1 198.163.152.190 53

syslog_fifo_path /root/syslogfifo

gui_fifo_path /root/guififo

tcp_listener_port 81

udp_listener_port 81

priority

1 target www.*.ca service http

2 target www.*.com service http

1 source 192.168.3.190

2 source 10.140.6.10

set

As a result of previous listen.conf file, the IntelliNet server would handle any network request according to the priority rules as FIG. 23.

Streaming Media: SIP voice connection is one kind of stream media. With the implementation of SIP over IntelliNet, it is possible to transfer streaming media over IntelliNet. Please see detail in the SIP section above.

Flow Control and Optimizing TCP signaling: Learn how the flow control algorithms are implemented in the Linux kernel. Identify how congestion avoidance, slow start, and window advertisements are calculated. Determine how we can manipulate this TCP signaling in order to set the flow at an optimal value.

Auto-learning new application: There are always new ideas can be added in order to make IntelliNet system more intelligence. The ideal IntelliNet system with intelligent is that the system can add code to itself. If there were a new network application on the network, the program would watch the traffic and try to handle the packet. Eventually it can understand the pattern and add a new handler to handle this new application. This not only makes Internet access configuration free, it also makes the system programmer free.

Centralizing cookies: Most web pages, especially online shopping sites, use lots of cookies to store information about the client machines. Obviously, transferring cookies takes lots of resource on the network. The idea is to store the cookies on a centralized database machine. If a user moves from one machine to another machine, there's no need to create new cookies for the same web page he/she visited. Whenever the web server requests for cookie from a client, the IntelliNet server goes to this cookie database server and fetch the information about this client. This obviously reduces lots of network traffic.

IntelliNet

This section described the functionalities of IntelliNet. It covers concept of the implementation and some of the key component from the source code. For each section, the problem encountered during development will be mentioned. The project is developed under Red Hat 6.0 with kernel 2.2.14.

Architecture

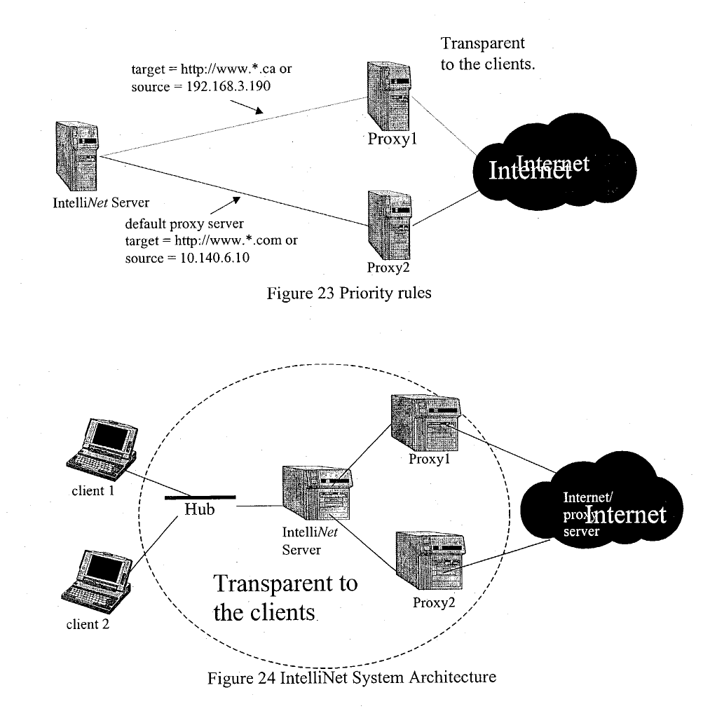

IntelliNet provides configuration free access to the Internet. A client with any arbitrary configuration or setup can connect to the network that has IntelliNet server running. The IntelliNet server provides a network looks like client's home network. Therefore the user can access the Internet as before without changing any configuration on the machine. See FIG. 24.

The concept of IntelliNet under Linux is basically same as IntelliNet for Windows NT, but with more features. There are several programs, arpspoof, ipchains and IntelliNet system, running on the IntelliNet machine. As described in the previous section, arpspoof accepts all ARP requests coming through the client-side network and responds with its client-side MAC address. The ipchains program is provided by the Linux system. According to the man pages of ipchains, ipchains is used to set up, maintain, and inspect the IP firewall rules in the Linux kernel. These rules can be divided into 4 different categories: the IP input chain, the IP output chain, the IP forwarding chain, and user defined chains. The rules specified on the IntelliNet machine redirect requests coming on different ports on the client side to the listener port, which is associated with a special file descriptor. The file descriptor would be set if a request comes in, then the IntelliNet program would take action upon the request. Other usages of ipchains will be described in the following sections as necessary. Last but not the least, the IntelliNet system processes both the requests from clients and the responses from proxy/internet. See details in following sections.

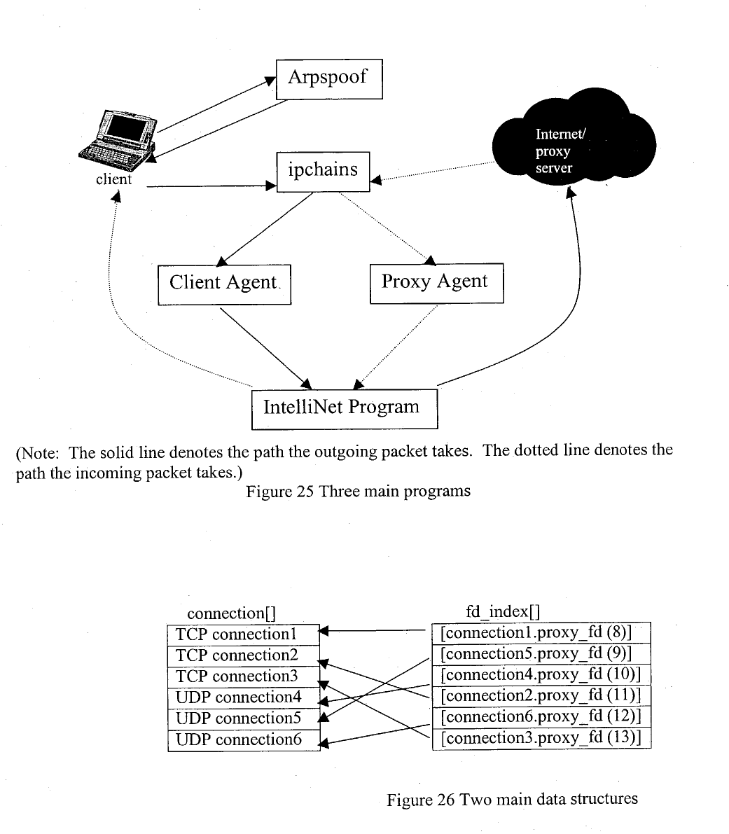

FIG. 25 shows how the three programs work together. On forward path, when the client sends a network request for the first time, it always sends an ARP request looking for its gateway or proxy. The arpspoof on the IntelliNet machine would accept the request and respond with its MAC address. The client machine would have this MAC address in the entry for its default proxy or gateway in the arp table. Once the client located its default proxy or gateway, it will send the first internet request. The ipchains program running on IntelliNet redirects the incoming request to the listener port. The client agent would start to act and let the IntelliNet program handles and pass on the request. On the reverse path, when the internet/proxy responds to the request, the ipchains program redirects or accepts the responses on the listener ports. Then the proxy agent triggers the IntelliNet program to locate the actual client who sent the original request and passes it on. The process is done. This is basically how every request being processed on ReayNet is handled. The following section covers the details on how each connection type handled.

Client agent, ReayNet program, and proxy agent are three main component [symbol] of the system. There are two important data structures, connections and fd_index [symbol] . They are illustrated as follows.

// connection [symbol] is an array of the following structure.
struct connection_t {

| | |
|---|---|
| int in_use; | // flag: 0=unused 1=used |
| struct sockaddr_in client_addr; | // address of the client |
| struct sockaddr_in proxy_addr; | // address of the proxy |

| | |
|---|---|
| struct sockaddr_in packetDestination; | // packet's destination |

| | |
|---|---|
| int client_fd; | // client socket file descriptor |
| int proxy_fd; | // proxy socket file descriptor |

| | |
|---|---|
| int connType; | // connection type |

| | |
|---|---|
| int service; | // service type (FTP, etc.) |
| long int lastUpload; | // # bits upload recently |

| | |
|---|---|
| long int lastDownload; | // # bits download recently |

| | |
|---|---|
| int currDirection; | // direction of current packet |
| char data[100]; | // protocol-specific data |
| int protocolType; | // TCP or UDP |
| time_t lastUsed; | // last time used |

}
struct connection_{‘3}t *fd_index[MAX_CONNECTIONS];
// array that points into connection [symbol] based on proxy socket file descriptor
// or the predefined port listener file descriptor.

The connection array, connection [symbol] , holds all existing connections on the network. The program adds a new entry into the array when a non-existing connection established on the network. It also adds the address of this connection to fd_index [symbol] , which is indexed by the proxy socket file descriptor (proxy_fd) or file descriptor for the proxy side listener port for this connection, in order to locate the client when this server receives responses on the port associated with this file descriptor. FIG. 26 shows how two data structures related.

These two data structures made IntelliNet possible to implement. The major components of IntelliNet are client agent, proxy agent, connection table (connection [symbol] ), and table index (fd_index [symbol] ). The client agent is a file descriptor that is associated to the listener port on the client side. Whenever a request initiated by one of the client, this file descriptor is set and checks if it's an existing connection by matching the source ephemeral port and IP address against the port number and IP address of all connections in the table. If the connection does not exist in the table, the agent adds the new connection to the table and updates the table index, then sends the request off to the appropriate handler base on the destination port of the packet. The handler forwards the request to its destination or proxy server. The proxy agent is a file descriptor that is associated to the listener port or the ephemeral port that sends the request on the proxy side. Whenever a response comes back from internet or proxy server, this files descriptor is set and look up for the client in the table index. Once it locates the client who send the original request, it pass the packet to the appropriate handler based on the source port. The handler forwards the response to the client. FIG. 27 illustrates the procedure just described.

The source code is divided into four files. The config.h file reads in and initializes the proxy server table, priority table, and network information on the IntelliNet server. All these information is stored in a file called listen.conf. The content of this file was explained in IntelliNet new features section.

The main.c file (Algorithm 38) acts like the client agent and proxy agent. It pulls everything together.

The tools.h file provides most of the functions used in the main.c file. The following sections describe how each type of request is handled (the handlers.h file) in detail.

HTTP

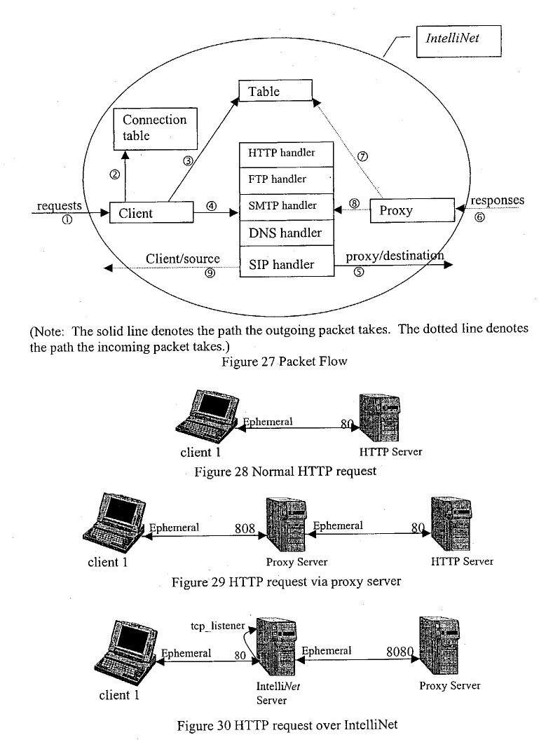

In normal HTTP request (FIG. 28), the client sends the request from an ephemeral port to well-known port 80 on the HTTP server. The IP address of the HTTP server is solved by DNS server. The HTTP server sends the response back to the same ephemeral port on the client machine.

With a HTTP proxy server on the network (FIG. 29), the client sends the request from an ephemeral port to pre-configured port, say port 8080, for HTTP request on the HTTP proxy server. The IP address of the HTTP proxy server is configured into the browser on the client machine. The proxy server will handle the request as usual and send the response back to this client.

On IntelliNet network (FIG. 30), the client can send either proxy HTTP request or non-proxy HTTP request to IntelliNet machine instead of its actual HTTP server or HTTP proxy server because of arpspoof program. The ipchains redirects the request to this TCP listener port and masquerades the source IP address in the IP header with the IP address on this machine. Because of ipchains program, the port number setup for proxy server on the client machine can be any port number. All packets are redirected to the TCP listener port eventually. The IntelliNet server then sends the request off to the appropriate HTTP proxy server. The HTTP proxy server processes the request as if the request was sent off from IntelliNet server and responds to it. When IntelliNet server receives the response, it locates the client by look up the fd_index with the file descriptor, which is associated with this ephemeral port. Finally, the response is sent back to the client.

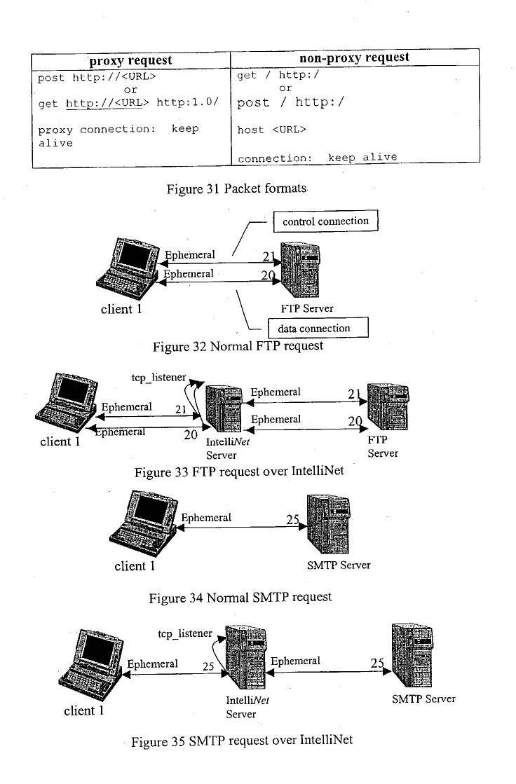

The real destination IP address can't be found in the IP header of a proxy HTTP packet, since the destination IP in the IP header is the IP of the proxy server. Luckily the real destination IP address is always in the packet following the keyword ‘http://’. The http_connection( ) (Algorithm 39) function in handlers.h file looks for destination IP address in the packet regardless the request type (proxy or non-proxy). It then gets the appropriate HTTP proxy server for this connection according to the priority rules, and establishes connection between IntelliNet machine and the HTTP proxy server on the port open for HTTP requests. The http_handler( ) (Algorithm 40) function in handlers.h file handles the HTTP requests. FIG. 31 gives the formats for both proxy request and non-proxy request.

For proxy requests, there's no need to modify the packet since the packets are sent in proxy-request format, and no client IP address appears in the packet. For non-proxy requests, the packets are in different format than proxy request. Therefore, the packets need to be rewrite so it looks like a proxy request packet.

FTP

File Transfer Protocol (FTP) (FIG. 32) is the internet standard for file transfer. FTP provides file transfer from one system to another system. FTP is a little bit different from most network applications. It uses two TCP connections to transfer files. One is control connection, the other one is data connection. The client establishes the connection by sending packet to port 21 on the FTP server. The server passively opens the port 21 and wait for connection from client. This connection stays up for the as long as there is communicates between the client and server. The data connection is created each time a file is transferred between the client and server.

With IntelliNet (FIG. 33), the client establish the FTP control connection with the IntelliNet server since the arpspoof program made the client think it's talking to the actual FTP server. The ipchains redirects the request to this TCP listener port and masquerades the source IP address in the IP header with the IP address on this machine. The IntelliNet server then establishes the FTP control connection with the appropriate FTP server. The FTP server opens port 21 and wait for connection from IntelliNet server. When client sends the command for any file transfer, the data connection is established on port 20. The ipchains program does the same thing here again. The IntelliNet server sends the command for file transfer as a client to the FTP server. Then the data (file) is transferred on the data connection on both sides of IntelliNet server.

The ftp_connection( ) (Algorithm 41) function in handlers.h file establishes both control connection and data connection between IntelliNet server and the FTP server accordingly. The ftp_handler( ) (Algorithm 42)function in handlers.h file handles the FTP requests. For data connection, there's no need to modify the packet since no client IP address appears in the packet. For control connection, the client IP address appears in the PORT command. The PORT command is the command establishes FTP connection. So ftp_handler( ) function has to pay special attention to this packet. First it replaces the client IP address with the proxy side IP address of the IntelliNet server. Then it records the connection information into a variable named “data” in the connection structure. This variable will be used to establish data connection with this original control connection.

SMTP

Simple Mail Transfer Protocol (SMTP) is the de facto standard for internet's message. SMTP uses TCP. It is used mainly for sending emails.

In normal SMTP request (FIG. 34), the client sends the request from an ephemeral port to well-known port 25 on SMTP server. The IP address of the SMTP server is entered on the client machine. The SMTP server sends the response back to the same ephemeral port on the client machine.

On IntelliNet network (FIG. 35), the client sends a SMTP request to IntelliNet machine instead of its actual SMTP server because of arpspoof program. The ipchains redirects the request to this TCP listener port and masquerades the source IP address in the IP header with the IP address on this machine. The IntelliNet server then sends the request off to the appropriate SMTP server. The SMTP server processes the request as if the request was sent off from IntelliNet server and responds to it. When IntelliNet server receives the response, it locates the client by look up the fd_index with the file descriptor, which is associated with this ephemeral port. Finally, the response is sent back to the client.

The smtp_connection( ) (Algorithm 43) function in handlers.h file gets the appropriate SMTP server for this connection according to the priority rules, and established the connection between IntelliNet server and the appropriate DNS server. The smtp_handler( ) (Algorithm 44) function in handlers.h file handles the SMTP requests. There's no need to modify the packet since no client IP address appears in the packet.

DNS

Domain Name System (DNS) is a distributed database that provides the mapping between IP addresses and hostnames. DNS mainly uses UDP. Most network requests start with DNS request.

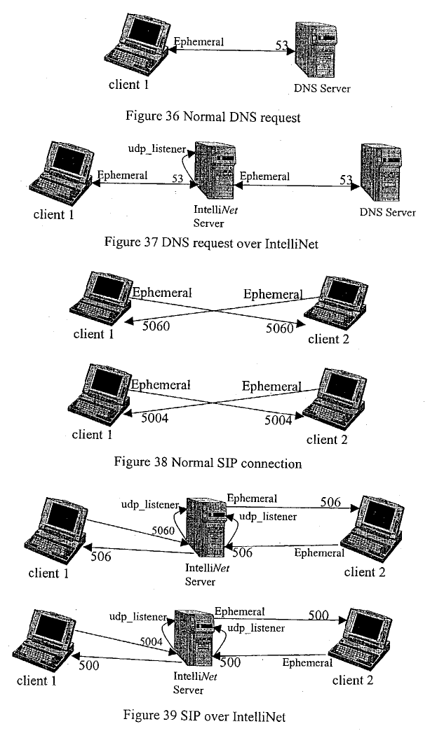

In normal DNS request (FIG. 36), the client sends the request from an ephemeral port to well-known port 53 on DNS server. The IP address of the DNS server is entered on the client machine. The DNS server sends the response back to the same ephemeral port on the client machine.

On IntelliNet network (FIG. 37), the client sends a DNS request to IntelliNet machine instead of its actual DNS server because of arpspoof program. The ipchains redirects the request to this UDP listener port and masquerades the source IP address in the IP header with the IP address on this machine. The IntelliNet server then sends the request off to the appropriate DNS server. The DNS server processes the request as if the request was sent off from IntelliNet server and responds to it. When IntelliNet server receives the response, it locates the client by look up the fd_index with the file descriptor, which is associated with this ephemeral port. Finally, the response is sent back to the client.

The dns_connection( ) (Algorithm 45) function in handlers.h file gets the appropriate DNS server for this connection according to the priority rules, and established the connection between IntelliNet server and the appropriate DNS server. The dns_handler( ) (Algorithm 46)function in handlers.h file handles the DNS requests. There's no need to modify the packet since no client IP address appears in the packet.

SIP

According to SIP center web site, SIP (Session Initiation Protocol) is a protocol developed to assist in providing advanced telephony services across the internet.

The most obvious reason for using SIP is that it is an UDP application. In order to make UDP working on the IntelliNet, we have to choose an application to test with. There are lots of UDP applications, such as MS NetMeeting, Real Player, SIP. MS NetMeeting uses mix of TCP and UDP connections. Real Player mainly uses TCP connection as well. SIP uses pure UDP connection and logs the actual packets automatically. It's an ideal application test UDP on IntelliNet.

The SIP program kind of works the same way as FTP. It establishes connection on one port and transfer voice over another port. For the version of SIP we are using, it's using port 5060 for connection and port 5004 for voice. FIG. 38 illustrates normal SIP connection.

Because the response from client 2 is coming back only on port 5060 and 5004 instead of the ephemeral port sent the request, we need to hard code the port number. Our solution is to use ipchains to redirect all UDP responses to a particular port (udp_proxyListener_port) on the proxy side. In order to identify the client (client 1) who sent the SIP connection request, the fd_index[udp_proxyListener_port] is set to point to the connection data structure, which includes client's IP. Whenever the response from client 2 coming back on port 5060, udp_proxyListener_port will be set and IntelliNet would start to receive data and pass them to client 1.

If there is more than one SIP connection, a table is needed to locate the corresponding caller client based on responses from callee client. Since this is just a proof of concept, an assumption, only one SIP connection on the network, is made. Another problem raised from the udp_proxyListener_port solution is that both DNS and SIP responses are redirect to this port, two types of responses cannot be distinguished. One possible solution is that using ipchains to update the rules on the fly. Whenever a DNS is established, a new rule is inserted to the beginning of the list to accept (forward) the any traffic on the ephemeral port sent this DNS request. When the DNS connection timed out, the rule will be removed accordingly. FIG. 39 gives better picture on how SIP work over IntelliNet.

There are only 6 different data packets. They are INVITE, RING, INVITE OK, ACK, BYE, and BYE OK. The Figure illustrates how the packets work together in sequence.

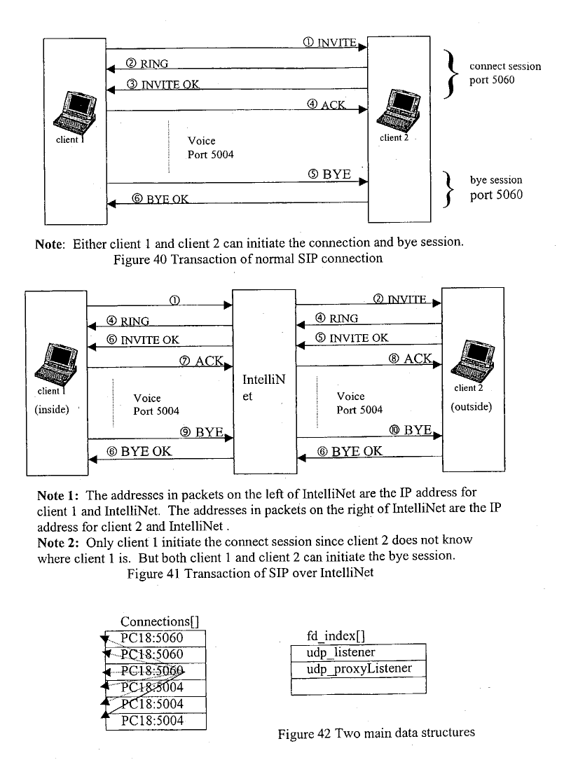

Normal SIP connection (FIG. 40)

SIP connection over IntelliNet (FIG. 41)

FIGS. 40 and 41 show that the IntelliNet take the normal packets and rewrite them with its own IP address. So the SIP user agent on the outside thinks it's talking to IntelliNet instead of client 1. Client 1 thinks it's talking to client 2, but actually talking to IntelliNet.

The sip_connection( ) (Algorithm 47) function in handlers.h file establishes the connection between IntelliNet server and the outside client. The sip_handler( ) (Algorithm 48) function in handlers.h file handles both SIP connection and voice connection. The only difference between these two connections is that we need to modify the data packet sent through SIP connection. There's no need to modify the voice packet if the connection was established properly. The SIP connection packet always starts with the keywords. Therefore, if the first character in the packet is a letter in the alphabetic, it's a data packet.

Another reason why sip_handler( ) handles both SIP connection and voice connection is that once the SIP connection and voice connection established on the network, the IntelliNet can not get any SIP connection packet from the client on the outside of the network. FIG. 42 shows why.

FIG. 42 briefly shows the different states of both data structures in SIP connecting process. Once the connection is established, the voice is sent through port 5004 back and forth until one client send a “BYE” packet. It's always easy to send something from inside to the outside. But when the outside responses, udp_proxyLisener_fd would be set and the connection corresponding to this file descriptor is the voice connection on port 5004. If there are handlers handling the SIP connection and void connection separately, the voice handler would pick up this packet since this connection's client side port number is 5004. Therefore all data packet after the voice connection is established are treaded as voice packet. In other words, they are lost on the network. One scenario is that the “BYE” packet or the “BYE OK” packet initiate by the user agent on the outside would never make it back to the inside user agent. Current sip_handler( ) changes the client side port to 5006 if it sees a data packet coming, otherwise it sets the client side port to 5004. This works only because of the assumption that there's only one SIP connection on the network.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A system for high streaming media performance over the network and optimized the flow control of the current computer networking system comprising:
a plurality of local networks which can connect a number of computers together including, as defined hereinafter, a client computer, a Content Locator, an Edge Server; a first Gateway, and a Peering Gateway;
wherein the Peering Gateway computer:
manages the whole bypass network consisting of several local networks;
connects to the Internet and communicates with its peers and the Content Locators via this interface;
has one interface with Gigabit link which connects to the backbone of the peering ISPs bypass networks such that all Peering Gateways on the backbone transfer data via this interface;
has one interface with Gigabit link which connects to the Content Locators on its bypass network such that data is transferred from and to the Content Locators via this interface;
is further programmed to respond to all client log on/off request regardless their home network where either the client is a customer of current ISP or customer of peered ISPs, such that the Peering Gateway replies to the Content Locator with the client's account information as confirmation;
wherein each local network:
has a predetermined domain identifier for identification of computers on this network;
consists one Content Locator, a plurality of Edge Servers and the first Gateway;
is managed by the Content Locator and has a Gigabit network link in parallel to the Internet connections;
wherein the Content Locator:
handles the incoming client request from either the client computer or the first Gateway and eventually makes the requested content available on one of the Edge Servers;
connects to the Internet and communicates with its peered Content Locators, the Peering Gateway, the Edge Servers and first Gateways via this interface;
has one interface with Gigabit link which connects to the backbone of the bypass networks such that the Content Locators of each local network transfer data via this interface;
has one interface with Gigabit link connects to the local network such that Data is transferred from and to the Edge Servers via this interface;
is programmed to receive all network requests coming from the first Gateway or client computer on the local network, then locate the content on both local and peered Edge Servers, where if the content is not available on the local Edge Servers, the Content Locator makes it available on one local Edge Server and informs the first Gateway or client computer;
is further programmed to load balance the local network by transferring the requested content to the least busy Edge Server such that, when selecting the Edge Server on peered local networks to transfer the requested content, the Content Locator makes decision based on predefined priority rules for its peering networks;
is further programmed to query the Edge Server on either local or peered local networks regarding the requested content and to actively balance the network traffic such that, before allowing file transfer between Edge Servers, the Content Locator contacts the actual web servers for acknowledgement;
is further programmed to reduce network traffic by accepting percentage of work load and network load from Edge Servers and peered Content Locators respectively and to combine the load percentage of each local Edge Server and various network factors to compute the network load;
is further programmed to accept transfer status from the first Gateway and Edge Server in order to handle network transformation failure in time;
is further programmed to record the transaction history for appropriate user account according to the status report by first Gateway or client computer for billing purpose;
wherein the Edge Server:
provides cache and streaming services for the local network;
connects to the Internet and communicates with the Content Locator and first Gateway or client computer via this interface;
has one interface with Gigabit link which connects to the local network to transfer data to and from the Content Locator;
is further programmed to translate the content query to cache language in order to check the content in the cache and to translate the incoming request to the appropriate streaming server's language in order to start streaming;
wherein the first Gateway:
accepts and forwards the client requests to Content Locator and contacting the Edge Server according to the Content Locator's response;
connects to the Internet and communicates with the Content Locator and Edge Servers via this interface;
has another interface with normal connection to communicate with clients;
is further programmed to distinguish large file requests from regular web requests;
is further programmed to detect streaming failure and inform the Edge Server and Content Locator immediately and also to report transfer status for each transaction to the Content Locator;
wherein the client computer:
is a regular client machine with the first Gateway function embedded;
is further programmed to self-configure as a client of the local network hosted by the Content Locator on start up such that client computer simply probes for existing Content Locator on the network and, upon the response, it self-configures the responding Content Locator as the default server;
and wherein the computers, which have more than one interface, have the IP address with different subnet on each network interface card.

2. The system according to claim 1 wherein, when log on/off requests arrives at the Peering Gateway, the Peering Gateway validates the information by matching the record in the database and sends confirmation to the Content Locator accordingly such that the account database is updated if the Content Locator sends a list of transaction history at log off time.

3. The system according to claim 1 wherein all client requests are forwarded to the Content Locator such that the Content Locator tries to local the requested content on the local network or the peered local networks and such that:
a) the Content Locator broadcasts the content query on the local network first and if one of the local edge servers has the content, its address is recorded as source edge server;
b) if a) failed, the Content Locator broadcasts the same query on its peered local networks with the edge server being chosen based on the load percentage and priority of the local network and with the chosen edge server being recorded as the source edge server;
c) and if b) failed, the Content Locator forwards the request to the original web server with a flag indicating not found in cache.

4. The system according to claim 1 wherein all client requests are forwarded to the Content Locator and the Content Locator forwards the original request as a bypass network request to distinguish from original web request leaving the web server to do the content locating.

5. The system according to claim 1 wherein the Content Locator sends the request and a flag, which indicates whether the content was found on the network, to the actual web site and either:
a) If the content is found, the actual web site only confirms the request with an acknowledgement so that if the source Edge Server is not on home local network, the data would transferred via the Gigabit links from the source Edge Server to the least busy local Edge Server chosen by the Content Locator.
b) In the case of content not found anywhere, the actual web site replies with the acknowledgement and starts to transfer data either via the bypass or the Internet depending on the actual web server's network configuration whereupon the Content Locator accepts the acknowledgement and forwards the data to the least busy edge server for caching.

6. The system according to claim 5 wherein, when the requested content is available on one of the local Edge Servers, the Content Locator informs the first Gateway or client computer of the source Edge Server address and the first Gateway or client computer contacts the Edge Server and start streaming, meanwhile it reports the status to the Content Locator accordingly.

7. The system according to claim 5 wherein the requests arrive at the Content Locator directly from the requester or from the Edge Server depending on the target web server's location and the Content Locator performs two levels of content locating is described as follows:
a) The Content Locator broadcasts the content query on the local network first so that, if one of the local edge servers has the content, its address is recorded as source edge server; and
b) If a) failed, the Content Locator broadcasts the same query on its peered local networks and the edge server is chosen based on the load percentage and priority of the local network so that the chosen edge server is recorded as the source edge server;
c) The Content Locator replies to the bypass network web request with the address of chosen source edge server and the acknowledgement so that the Content Locator replies to the ordinary web request with requested content via the Internet, since the request originates from an off bypass network client.

8. The system according to claim 1 wherein the Content Locator broadcasts the query on both local network and its peered networks accordingly such that in either handling original request or incoming multicast message, the Content Locator always does the two-level query accordingly:
a) Broadcast on the local network and if a positive response is received, the Content Locator replies to the requester with the result; and
b) If a) failed, the Content Locator continues to multicast the query on its peered local networks and upon receipt of the query results from each peered local network, it picks the edge server based on the load percentage and the priority of the local network, and replies to the requester.

9. The system according to claim 1 wherein, on a regular basis, the Content Locator pings each peered Content Locator to ensure it is still alive, and network status of each peered network is sent to the Content Locator and the Content Locator also pings each local Edge Server to ensure it is alive, and load status is sent by the Edge Server to the Content Locator so that, combining the status of all Edge Servers and traffic load, the Content Locator calculates the load percentage of the local network.

10. The system according to claim 9 wherein, when the Content Locator informs the client which Edge Server to stream the requested content, it creates a new transaction record, which includes account ID, URL, file size, status, and the transaction record is updated according to the streaming status provided by the first Gateway or client computer wherein the transaction history contains all the transaction records during the user's log on time and this information is saved on the Peering Gateway during log off session.

11. The system according to claim 1 wherein, if a transaction failure occurs on the Edge Server, the first Gateway or client computer detects it and informs the Content Locator whereupon the Content Locator parses the status report (failure notice) and updates the transaction record and then makes the content available on an alternative Edge Server.

12. The system according to claim 1 wherein the Edge Server computes the percentage of load on a regular basis and sends it to the Content Locator wherein this factor can be used to determine the least busy Edge Server on the network for load balancing the Edge Servers

13. The system according to claim 1 wherein there are two types of requests, bypass network web request and original web request and the web servers on the bypass network are designed to handle both types of the requests, wherein the bypass network web request is responded to with the address of chosen source edge server and the acknowledgement and the ordinary web request is responded to with the requested content via the Internet in view of the fact that the request was sent by an off bypass network client.

14. The system according to claim 1 wherein, since the Edge Server is running all kinds of streaming servers, cache servers and web servers, the incoming bypass network message is translated to the message which can be understood by the appropriate application and the Edge Server is further programming to capable to translate the bypass network message to different server messages.

15. The system according to claim 1 wherein the first Gateway is arranged to check the status of each opening port for incoming streaming data and, if one port times out, it sends the Edge Server a termination notice and closes the port and, if the streaming session ends maturely, the first Gateway simply sends the Content Locator to confirm the success and otherwise, it sends a status to the Content Locator.

16. The system according to claim 1 wherein, when a client computer connects the network, it first sends out a special message searching for a Content Locator on the bypass network and, if such server replies, the client computer self-configures as a client machine on this local network by setting this server as default Content Locator whereupon the user logs on/off via the Content Locator as usual and, if the client computer is not on any CDN bypass network, it directly communicates with the home Peering Gateway over the Internet and finds a nearby local network so that the ISP sets up an first Gateway on selected local network to accept requests from clients on other networks.

17. The system according to claim 1 wherein the communication computer is further programmed:
a) When the user logs on to the Content Locator, a copy of the user account information is transferred to the Content Locator from user's home Peering Gateway; and
b) The Content Locator maintains a local copy of the user account information so that there is a transaction history link to each account currently active on the Content Locator and the Content Locator updates the transaction history base on the transaction status reported by the first Gateway or client computer; and
c) During log off session, the transaction history and the updated account information are sent to the user's home Peering Gateway for billing purpose; and
d) The user is billed based on amount of data transferred and log on duration.

18. The system according to claim 1 wherein, on startup of each server (Peering Gateway, Content Locator, Edge Server, and first Gateway), it actively informs its upper level server and the peered server about its existence so that all peer networks are aware of the newly peered network automatically.
